(19) United States
(12) Patent Application Publication
(10) Pub. No.: US 2020/0036944 A1
(43) Pub. Date: Jan. 30, 2020

(54) METHOD AND SYSTEM FOR VIDEO TRANSMISSION

(71) Applicant: SZ DJI TECHNOLOGY CO., LTD., Shenzhen (CN)

(72) Inventors: Lei ZHU, Shenzhen (CN); Hao CUI, Shenzhen (CN); Ming GONG, Shenzhen (CN)

(21) Appl. No.: 16/589,119

(22) Filed: Sep. 30, 2019

Related U.S. Application Data
(63) Continuation of application No. PCT/CN2017/079370, filed on Apr. 1, 2017.

(51) Int. Cl. H04N 7/18; H04N 19/436; H04N 7/08

(52) U.S. Cl. CPC H04N 7/185; H04N 7/0806; H04N 19/436

(57) ABSTRACT

A method for transmitting video from a movable object includes decomposing video data into a plurality of sub-video data units, encoding the plurality of sub-video data units individually to generate a plurality of coded sub-video data units, and selecting at least one of the plurality of coded sub-video data units for transmission according to one or more characteristics the sub-video data units and one or more channel conditions of a plurality of channels.

### CROSS-REFERENCE TO RELATED APPLICATION

This application is a continuation of International Application No. PCT/CN2017/079370, filed on Apr. 1, 2017, the entire content of which is incorporated herein by reference.

### BACKGROUND

Unmanned vehicles, such as ground vehicles, air vehicles, surface vehicles, underwater vehicles, and spacecraft, have been developed for a wide range of applications including surveillance, search and rescue operations, exploration, and other fields. In some instances, unmanned vehicles may be equipped with sensors for collecting data from the surrounding environment. For example, unmanned aerial vehicles are commonly provided with cameras for aerial photography.

The sensing data such as video data collected by the unmanned vehicle can be transmitted to a remote user in real time. However, existing approaches for video data transmission from unmanned vehicles can be less than ideal. For example, when the code rate of the video data fluctuates due to a change in the condition of the communication channel (e.g., bandwidth), the transmission may be delayed and the average code rate can only be controlled over a number of frames instead of at the frame or sub-frame level.

### SUMMARY

Thus, a need exists for an improved system and method of wireless transmission of video data. The present disclosure provides system, method, and devices related to wireless transmission of video data from a movable object with low latency. Transmission delay or jittering of the images may be reduced by dynamically matching the communication channels or communication links to the video data at sub-frame level. A video data stream may be decomposed into a plurality of sub-video data streams and the sub-video data stream comprises one or more sub-images (sub-frames). Each sub-image may be a component of a spatial decomposition of an image frame. Each sub-video data stream may be individually encoded and selected for transmission according to a real-time channel condition. The sub-video data streams may be selected and transmitted using multi-link or single-link data transmission. The sub-video data streams may be selected and organized to be adaptive to changes in channel condition. The method may be provided for video transmission with improved resilience to transmission errors. Error propagation with the same image frame or successive image frames can be prevented by reconstructing the image frame using correctly received sub-video data streams, thus the erroneous sub-image may not lead to a loss of the entire image frame.

In one aspect, a method for transmitting video from a movable object is provided. The method may comprise: decomposing, with aid of one or more processors, a video data into a plurality of sub-video data units; encoding the plurality of sub-video data units individually; and selecting, with aid of the one or more processors, at least one of the plurality of coded sub-video data units for transmission according to one or more characteristics the sub-video data units and one or more channel conditions of a plurality of channels.

In a separate yet related aspect, a system for transmitting video from a movable object is provided. The system may comprise: one or more imaging devices configured to collect a video data; and one or more processors individually or collectively configured to: decompose the video data into a plurality of sub-video data units; encode the plurality of sub-video data units individually; and select at least one of the plurality of coded sub-video data units for transmission according to one or more characteristics the sub-video data units and one or more channel conditions of a plurality of channels.

In some embodiments, the video data comprises one or more image frames and wherein each image frame is decomposed into a plurality of sub-images. The image frame may be spatially decomposed using spatial sampling method or spatial transformation method. In some cases, the image frame is spatially decomposed into the plurality of sub-images using Fourier related transformation or orthogonal transformation such that each sub-image comprises a transformation result of a portion of the image frame. For instance, the transformation result comprises one or more transformation coefficients of the portion of the image frame. The Fourier related transformation or orthogonal transformation may be selected from Hadamard transformation, discrete cosine transformation, discrete Fourier transformation, Walsh-Hadamard transformation, Haar transformation, or Slant transformation. In some cases, the image frame is spatially decomposed into the plurality of sub-images using spatial down-sampling such that each sub-image comprises a sub-set of pixels of the image frame.

In some embodiments, each sub-video data unit has the same length as the video data or the plurality of sub-video data units have the same length. The plurality of sub-video data units may be encoded in parallel. In some instances, the plurality of sub-video data units are encoded by a plurality of individual encoders and at least one of the plurality of individual encoders uses motion-compensation-based video compression standard. The plurality of sub-video data units are encoded using different video coding schemes or parameters or using the same video coding schemes or parameters. In some instances, two or more of the plurality of sub-video data units are encoded by a single encoder. In some cases, the plurality of sub-video data units are compressed at different compression ratio which in some instances, may be determined according to the one or more characteristics of the sub-video data units.

In some embodiments, the one or more characteristics of the plurality of sub-video data units include a size of the coded sub-video data units, or an energy concentration. In some cases, the plurality of sub-video data units are prioritized according to the energy concentration. For instance, the sub-video data unit comprises low frequency coefficients has high energy concentration and may have high priority. In some instances, the plurality of sub-video data units have substantially similar characteristics thus they may have equal priority.

In some embodiments, the one or more channel conditions include at least one of noise, interference, signal-to-noise ratio, bit error rate, fading rate or bandwidth. In some instances, each individual sub-video data unit is transmitted using one of the plurality of channels. Different sub-video data units are assigned to different channels according to a priority of the sub-video data unit and the channel condition or according to a size of the coded sub-video data unit and the bandwidth of the channel. In some instances, the plurality of sub-video data units are organized into one or more groups according to the channel conditions. The plurality of sub-video data units are organized such that a size of a group matches a bandwidth of a selected channel or the plurality of sub-video data units are organized into one or more groups according to the number of available channels. In some instances, a group of sub-video data units is transmitted using one of the plurality of channels. The group of sub-vide data units are selected according to a size of the group and a bandwidth of the channel or are selected according to a priority of the sub-video data units.

In some embodiments, the method may further comprise receiving and decoding the plurality of sub-video data units. After receiving the sub-video data units, the plurality of sub-video data units are decoded individually. The method may further comprise identifying one or more erroneous sub-images or sub-video data. In some cases, the one or more erroneous sub-images or sub-video data are identified by detecting a transmission error. Once the one or more erroneous sub-images are identified, the method further comprises assigning a value to the erroneous sub-images or the sub-video data units. The method may be zero or determined using an interpolation method. For instance, the value is determined based on interpolation of sub-images that are from the same original image frame as the one or more erroneous sub-images. The method further comprises reconstructing the video data using the sub-video data units. The video data may be reconstructed based on sub-video data units that are not erroneous and the value assigned to the erroneous sub-video data units. Depending on the decomposition method, the video data may be reconstructed by applying an inverse transformation.

In some embodiments, the movable object is an unmanned aerial vehicle (UAV), a land vehicle, a vehicle traversing water body, a mobile phone, a tablet, a laptop, a wearable device, or a digital camera. In some embodiments, the one or more imaging devices used for collecting the image data are operably coupled to the movable object via a carrier and the carrier is a multi-axis gimbal.

In another aspect of the disclosure, a method for transmitting video from a movable object using a single communication link is provided. The method comprises: decomposing, with aid of one or more processors, a video data into a plurality of sub-video data units; encoding the plurality of sub-video data units separately; and selecting one or more of the coded sub-video data units for transmission using a single channel, wherein the one or more of the coded sub-video data units are selected according to one or more conditions of the channel and one or more characteristics of the sub-video data units.

In a separate yet related aspect, a system for transmitting video from a movable object using a single communication link is provided. The system comprises: one or more imaging devices configured to collect a video data; and one or more processors individually or collectively configured to: decompose the video data into a plurality of sub-video data units; encode the plurality of sub-video data units separately; and select one or more of the coded sub-video data units for transmission using a single channel, wherein the one or more of the coded sub-video data units are selected according to one or more conditions of the channel and one or more characteristics of the sub-video data units.

In some embodiments, the one or more conditions of the channel include at least one of noise, interference, signal-to-noise ratio, bit error rate, fading rate or bandwidth. In some embodiments, the one or more characteristics of the sub-video data units include a size of the coded sub-video data units, or an energy concentration. In some instances, the one or more sub-video data units are selected such that a total size of the selected coded sub-video data units matches the bandwidth of the channel. In some instances, the plurality of sub-video data units are prioritized according to the energy concentration. In some cases, the one or more sub-video data units are selected according to the priority of the sub-video data units and the size of the coded sub-video data units.

In some embodiments, the video data comprises one or more image frames and wherein each image frame is decomposed into a plurality of sub-images. The image frame may be spatially decomposed using spatial sampling method or spatial transformation method. In some cases, the image frame is spatially decomposed into the plurality of sub-images using Fourier related transformation or orthogonal transformation such that each sub-image comprises a transformation result of a portion of the image frame. For instance, the transformation result comprises one or more transformation coefficients of the portion of the image frame. The Fourier related transformation or orthogonal transformation may be selected from Hadamard transformation, discrete cosine transformation, discrete Fourier transformation, Walsh-Hadamard transformation, Haar transformation, or Slant transformation. In some cases, the image frame is spatially decomposed into the plurality of sub-images using spatial down-sampling such that each sub-image comprises a sub-set of pixels of the image frame.

In some embodiments, each sub-video data unit has the same length as the video data or the plurality of sub-video data units have the same length. The plurality of sub-video data units may be encoded in parallel. In some instances, the plurality of sub-video data units are encoded by a plurality of individual encoders and at least one of the plurality of individual encoders uses motion-compensation-based video compression standard. The plurality of sub-video data units are encoded using different video coding schemes or parameters or using the same video coding schemes or parameters. In some instances, two or more of the plurality of sub-video data units are encoded by a single encoder. In some cases, the plurality of sub-video data units are compressed at different compression ratio which in some instances, may be determined according to the one or more characteristics of the sub-video data units.

In some embodiments, the method may further comprise receiving and decoding the plurality of sub-video data units. After receiving the sub-video data units, the plurality of sub-video data units are decoded individually. The method may further comprise identifying erroneous sub-images or sub-video data. In some cases, the erroneous sub-images or sub-video data are identified by detecting a transmission error. Once the erroneous sub-images are identified, the method further comprises assigning a value to the erroneous sub-images or the sub-video data units. The method may be zero or determined using an interpolation method. For instance, the value is determined based on interpolation of sub-images that are from the same original image frame as the erroneous sub-images. The method further comprises reconstructing the video data using the sub-video data units. The video data may be reconstructed based on sub-video data units that are not erroneous and the value assigned to the erroneous sub-video data units. Depending on the decomposition method, the video data may be reconstructed by applying an inverse transformation.

In some embodiments, the movable object is an unmanned aerial vehicle (UAV), a land vehicle, a vehicle traversing water body, a mobile phone, a tablet, a laptop, a wearable device, or a digital camera. In some embodiments, the one or more imaging devices used for collecting the image data are operably coupled to the movable object via a carrier and the carrier is a multi-axis gimbal.

In another aspect, a method of adaptive transmitting video from a movable object is provided. The method comprises: assessing, with aid of one or more processors, one or more characteristics of one or more channels; decomposing, with aid of the one or more processors, a video data collected by the movable object into a plurality of sub-video data units based on the assessed one or more characteristics of the one or more channels; encoding the plurality of sub-video data units separately; and selecting, with aid of the one or more processors, one or more of the channels for transmitting the coded sub-video data units;

In a separate yet related aspect, a system for adaptive transmitting video from a movable object is provided. The system comprises: one or more imaging devices configured to collect a video data; and one or more processors individually or collectively configured to: assess one or more characteristics of one or more channels; decompose the video data into a plurality of sub-video data units based on the assessed one or more characteristics of the one or more channels; encode the plurality of sub-video data units to generate a plurality of coded sub-video data units; and select one or more of the channels for transmitting the coded sub-video data units.

In some embodiments, the one or more characteristics of the one or more channels include at least one of noise, interference, signal-to-noise ratio, bit error rate, fading rate or bandwidth. In some embodiments, the one or more characteristics of the one or more channels include the number of available channels, symmetry/asymmetry according to the one or more characteristics across the one or more channels. The one or more characteristics of the plurality of channels are assessed by checking a signal strength or a location of the movable object.

In some embodiments, the video data is decomposed into a plurality of sub-video data units using a method selected based on the one or more assessed characteristics of the one or more channels. In some cases, the method determines the number of the sub-video data units. In some cases, the method is selected such that sub-video data units have substantially similar characteristics such as using a spatial sampling method. In some cases, the method is selected such that the plurality of sub-video data units have different characteristics such as using a spatial transformation method. The one or more characteristics of the plurality of sub-video data units include a size of the coded sub-video data units, or an energy concentration.

In some embodiments, the plurality of sub-video data units are organized into one or more groups according to the one or more characteristics of the one or more channels and each group comprises one or more sub-video data units. In some cases, the one or more channels are selected according to a size of the group and the bandwidth of the channel or the one or more channels are selected according to a size of the group and the bandwidth of the channel.

Once the decomposition or transmission method is determined, the method further comprises transmitting information about a method used for decomposing the video data into the plurality of sub-video data units. In some instances, the information is included in the plurality of sub-video data units. For example, the information is embedded in a special field of a data structure comprising the at least a portion of the sub-image data. Alternatively, the information is transmitted using a separate channel and may be transmitted prior to transmission of the plurality of sub-video data units.

In some embodiments, the method may further comprise receiving and decoding the plurality of sub-video data units. After receiving the sub-video data units, the plurality of sub-video data units are decoded individually. The method may further comprise identifying erroneous sub-images or sub-video data. In some cases, the erroneous sub-images or sub-video data are identified by detecting a transmission error.

The method may further comprise receiving information about a method used for decomposing the video data into the plurality of sub-video data units. Once the erroneous sub-images are identified, the method further comprises assigning a value to the erroneous sub-images or the sub-video data units based on the received information. The method may be zero or determined using an interpolation method. For instance, the value is determined based on interpolation of sub-images that are from the same original image frame as the erroneous sub-images. The method further comprises reconstructing the video data using the sub-video data units. The video data may be reconstructed based on sub-video data units that are not erroneous and the value assigned to the erroneous sub-video data units. Depending on the decomposition method, the video data may be reconstructed by applying an inverse transformation.

In some embodiments, the video data comprises one or more image frames and wherein each image frame is decomposed into a plurality of sub-images. The image frame may be spatially decomposed using spatial sampling method or spatial transformation method. In some cases, the image frame is spatially decomposed into the plurality of sub-images using Fourier related transformation or orthogonal transformation such that each sub-image comprises a transformation result of a portion of the image frame. For instance, the transformation result comprises one or more transformation coefficients of the portion of the image frame. The Fourier related transformation or orthogonal transformation may be selected from Hadamard transformation, discrete cosine transformation, discrete Fourier transformation, Walsh-Hadamard transformation, Haar transformation, or Slant transformation. In some cases, the image frame is spatially decomposed into the plurality of sub-images using spatial down-sampling such that each sub-image comprises a sub-set of pixels of the image frame.

In some embodiments, each sub-video data unit has the same length as the video data or the plurality of sub-video data units have the same length. The plurality of sub-video data units may be encoded in parallel. In some instances, the plurality of sub-video data units are encoded by a plurality of individual encoders and at least one of the plurality of individual encoders uses motion-compensation-based video compression standard. The plurality of sub-video data units are encoded using different video coding schemes or parameters or using the same video coding schemes or parameters. In some instances, two or more of the plurality of sub-video data units are encoded by a single encoder. In some cases, the plurality of sub-video data units are compressed at different compression ratio which in some instances, may be determined according to the one or more characteristics of the sub-video data units.

In some embodiments, the movable object is an unmanned aerial vehicle (UAV)), a land vehicle, a vehicle traversing water body, a mobile phone, a tablet, a laptop, a wearable device, or a digital camera. In some embodiments, the one or more imaging devices used for collecting the image data are operably coupled to the movable object via a carrier and the carrier is a multi-axis gimbal.

It shall be understood that different aspects of the disclosure can be appreciated individually, collectively, or in combination with each other. Various aspects of the disclosure described herein may be applied to any of the particular applications set forth below. Other objects and features of the present disclosure will become apparent by a review of the specification, claims, and appended figures. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 illustrates a movable object transmitting video data to a remote terminal, in accordance with embodiments.

FIG. 2 shows an example of spatial decomposition of an image frame, in accordance with embodiments.

FIG. 3 shows an example of spatial decomposition of an image frame, in accordance with embodiments.

FIG. 4 shows a block diagram illustrating examples of components for processing image or video data and transmitting the video data, in accordance with embodiments.

FIG. 5 shows an exemplary process of transmitting video data with reduced latency.

FIG. 6 shows an example of reconstructing image frame or video data using correctly received sub-video data.

FIG. 7 shows an example of reconstructing image frame or video data using correctly received sub-video data.

FIG. 8 shows an example of adaptive transmission of video data, in accordance with embodiments

FIG. 9 shows an example of adaptive transmission of video data, in accordance with embodiments.

FIG. 10 shows a block diagram illustrating examples of components for adaptive video transmission, in accordance with embodiments.

FIG. 11 illustrates a movable object, in accordance with embodiments.

### DETAILED DESCRIPTION

Systems and methods are provided for wireless transmission of video data from a movable object with low latency. Transmission delay or jittering of the images may be reduced by dynamically matching the communication channels or communication links to the video data at sub-frame level. A video data stream may be decomposed into a plurality of sub-video data streams and the sub-video data stream comprises one or more sub-images (sub-frames). Each sub-image may be a component of a spatial decomposition of an image frame. Each sub-video data stream may be individually encoded and selected for transmission according to a real-time channel condition. The sub-video data streams may be selected and transmitted using multi-link or single-link data transmission. The sub-video data streams may be selected and organized to be adaptive to changes in channel condition. The method may be provided for video transmission with improved resilience to transmission errors. Previous transmission method may employ encoding or data compression techniques that may require reference information from other sub-frames or successive frame. Such transmission methods may cause error propagation due to a failure of an erroneous frame. The provided method or system may prevent error propagation within the same image frame or successive image frames by reconstructing the image frame using correctly received sub-video data streams, thus the erroneous sub-image may not lead to a loss of the entire image frame or the successive image frames.

It shall be understood that different aspects of the disclosure can be appreciated individually, collectively, or in combination with each other. Various aspects of the disclosure described herein may be applied to any of the particular applications set forth below or for any other types of remotely controlled vehicles or movable objects.

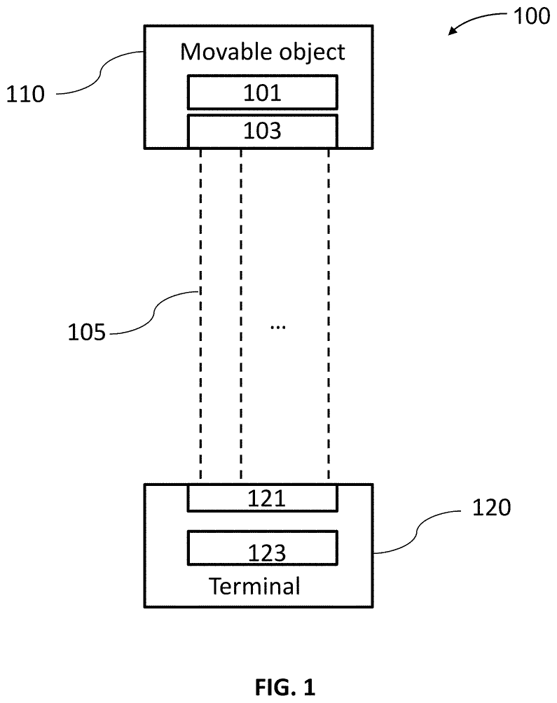

FIG. 1 schematically shows a system 100 including a movable object 110 and a remote terminal 120, and illustrates the movable object 110 transmitting video data to the remote terminal 120, in accordance with embodiments. Any descriptions herein of the movable object 110 transmitting video data to the terminal can also be applied to data transmission with any number of terminals or other suitable remote devices.

The movable object 110 can be configured to move within various environments (e.g., air, water, ground, space, or combinations thereof). In some embodiments, the movable object can be a vehicle (e.g., an aerial vehicle, water vehicle, ground vehicle, or space vehicle). The vehicle may be a self-propelled vehicle. The vehicle may traverse the environment with aid of one or more propulsion units. The vehicle may be an unmanned vehicle. The vehicle may be capable of traversing the environment without a human passenger onboard. Alternatively, the vehicle may carry a human passenger. In some embodiments, the movable object may be an unmanned aerial vehicle (UAV). Any description herein of a UAV or any other type of movable object may apply to any other type of movable object or various categories of movable objects in general, or vice versa. For instance, any description herein of a UAV may apply to any unmanned land-bound, water-based, or space-based vehicle.

Optionally, the movable object 110 can perform one or more functions. For example, the movable object can be a UAV provided with a camera for aerial photography operations. However, as previously mentioned, any description pertaining to an aerial vehicle such as a UAV may apply to any other type of movable object, and vice-versa. Further details on exemplary movable objects of the present disclosure are provided elsewhere herein.

The movable object 110 may be any object capable of traversing the environment. The movable object may be capable of traversing air, water, land, and/or space. The environment may include objects or topographies and various other factors (e.g., weather) that may affect radio signal propagation. The environment may comprise any structures or factors that may affect, for example, noise, fading, reflection or other characteristics of radio signal propagation. For example, in a cluttered or urban environment, the radio communication links may get sudden dropouts due to the reflected propagation path cancelling the direct propagation path. In some cases, an environment may result in asymmetry of communication links. For instance, different communication links may experience different propagation delay.

As mentioned above, the movable object 110 may be capable of traversing an environment. The movable object may be capable of flight within three dimensions. The movable object may be capable of spatial translation along one, two, or three axes. The one, two or three axes may be orthogonal to one another. The axes may be along a pitch, yaw, and/or roll axis. The movable object may be capable of rotation about one, two, or three axes. The one, two, or three axes may be orthogonal to one another. The axes may be a pitch, yaw, and/or roll axis. The movable object may be capable of movement along up to 6 degrees of freedom. The movable object may include one or more propulsion units that may aid the movable object in movement. For instance, the movable object may be a UAV with one, two or more propulsion units. The propulsion units may be configured to generate lift for the UAV. The propulsion units may include rotors. The movable object may be a multi-rotor UAV.

The movable object 110 may have any physical configuration. For instance, the movable object may have a central body with one or arms or branches extending from the central body. The arms may extend laterally or radially from the central body. The arms may be movable relative to the central body or may be stationary relative to the central body. The arms may support one or more propulsion units. For instance, each arm may support one, two or more propulsion units.

The movable object 110 may be configured to support an onboard payload. The payload may have a fixed position relative to the movable object, or may be movable relative to the movable object. The payload may spatially translate relative to the movable object. For instance, the payload may move along one, two or three axes relative to the movable object. The payload may rotate relative to the movable object. For instance, the payload may rotate about one, two or three axes relative to the movable object. The axes may be orthogonal to on another. The axes may be a pitch, yaw, and/or roll axis. Alternatively, the payload may be fixed or integrated into the movable object.

In some cases, the payload may be movable relative to the movable object with aid of a carrier (not shown). The carrier may include one or more gimbal stages that may permit movement of the carrier relative to the movable object. For instance, the carrier may include a first gimbal stage that may permit rotation of the carrier relative to the movable object about a first axis, a second gimbal stage that may permit rotation of the carrier relative to the movable object about a second axis, and/or a third gimbal stage that may permit rotation of the carrier relative to the movable object about a third axis. The carrier may allow the payload to be controlled to rotate about one or more rotational axes (e.g., roll axis, pitch axis, or yaw axis). Any descriptions and/or characteristics of carriers as described elsewhere herein may apply.

The payload may include a device capable of sensing the environment about the movable object, a device capable of emitting a signal into the environment, and/or a device capable of interacting with the environment. The payload may include one or more devices capable of emitting a signal into an environment. For instance, the payload may include an emitter along an electromagnetic spectrum (e.g., visible light emitter, ultraviolet emitter, infrared emitter). The payload may include a laser or any other type of electromagnetic emitter. The payload may emit one or more vibrations, such as ultrasonic signals. The payload may emit audible sounds (e.g., from a speaker). The payload may emit wireless signals, such as radio signals or other types of signals.

The payload may be capable of interacting with the environment. For instance, the payload may include a robotic arm. The payload may include an item for delivery, such as a liquid, gas, and/or solid component. For example, the payload may include pesticides, water, fertilizer, fire-repellent materials, food, packages, or any other item.

Any examples herein of payloads may apply to devices that may be carried by the movable object or that may be part of the movable object. For instance, one or more sensors may be part of the movable object. The one or more sensors may or may be provided in addition to the payload. This may apply for any type of payload, such as those described herein.

One or more sensors may be provided as a payload, and may be capable of sensing the environment. Some examples of types of sensors may include location sensors (e.g., global positioning system (GPS) sensors, mobile device transmitters enabling location triangulation), vision sensors (e.g., imaging devices capable of detecting visible, infrared, or ultraviolet light, such as cameras), proximity or range sensors (e.g., ultrasonic sensors, lidar, time-of-flight or depth cameras), inertial sensors (e.g., accelerometers, gyroscopes, and/or gravity detection sensors, which may form inertial measurement units (IMUs)), altitude sensors, attitude sensors (e.g., compasses), pressure sensors (e.g., barometers), temperature sensors, humidity sensors, vibration sensors, audio sensors (e.g., microphones), and/or field sensors (e.g., magnetometers, electromagnetic sensors, radio sensors). The one or more sensors may include an imaging device.

As illustrated in FIG. 1, the payload may include an imaging device 101. The imaging device may be configured to capture video data or image data. The video data or image data may be transmitted via a communication unit 103 onboard the movable object to a remote terminal 120.

An imaging device 101 may be a physical imaging device. An imaging device can be configured to detect electromagnetic radiation (e.g., visible, infrared, and/or ultraviolet light) and generate image data based on the detected electromagnetic radiation. An imaging device may include a charge-coupled device (CCD) sensor or a complementary metal-oxide-semiconductor (CMOS) sensor that generates electrical signals in response to wavelengths of light. The resultant electrical signals can be processed to produce image data. The image data generated by an imaging device can include one or more images, which may be static images (e.g., photographs), dynamic images (e.g., video), or suitable combinations thereof. The image data can be polychromatic (e.g., RGB, CMYK, HSV) or monochromatic (e.g., grayscale, black-and-white, sepia). The imaging device may include a lens configured to direct light onto an image sensor.

The imaging device 101 can be a camera. A camera can be a movie or video camera that captures dynamic image data (e.g., video). A camera can be a still camera that captures static images (e.g., photographs). A camera may capture both dynamic image data and static images. A camera may switch between capturing dynamic image data and static images. Although certain embodiments provided herein are described in the context of cameras, it shall be understood that the present disclosure can be applied to any suitable imaging device, and any description herein relating to cameras can also be applied to any suitable imaging device, and any description herein relating to cameras can also be applied to other types of imaging devices. A camera can be used to generate 2D images of a 3D scene (e.g., an environment, one or more objects, etc.). The images generated by the camera can represent the projection of the 3D scene onto a 2D image plane. Accordingly, each point in the 2D image corresponds to a 3D spatial coordinate in the scene. The camera may comprise optical elements (e.g., lens, mirrors, filters, etc). The camera may capture color images, greyscale image, infrared images, and the like. The camera may be a thermal imaging device when it is configured to capture infrared images.

The imaging device 101 may capture an image frame or a sequence of image frames at a specific image resolution. The image frame resolution may be defined by the number of pixels in a frame. The image resolution may be greater than or equal to about 352×420 pixels, 480×320 pixels, 720×480 pixels, 1280×720 pixels, 1440×1080 pixels, 1920×1080 pixels, 2048×1080 pixels, 3840×2160 pixels, 4096×2160 pixels, 7680×4320 pixels, or 15360×8640 pixels. The image frame may comprise a plurality of pixels as defined by the image resolution. In some cases, the image frame may be decomposed into a plurality of sub-images and each sub-image may comprise a portion of the pixels. The imaging device may have pixel size no more than 1 micron, 2 micron, 3 micron, 5 micron, 10 micron, 20 micron and the like. The camera may be, for example, a 4K camera or a camera with a higher resolution. Pixels of camera may be square. In other embodiments may take into account non-square pixels or other optical distortions. The imaging device may capture color images, greyscale image, and the like.

The imaging device 101 may capture a sequence of image frames at a specific capture rate. In some embodiments, the sequence of images may be captured at standard video frame rates such as about 24 p, 25 p, 30 p, 48 p, 50 p, 60 p, 72 p, 90 p, 100 p, 120 p, 300 p, 50i, or 60i. In some embodiments, the sequence of images may be captured at a rate less than or equal to about one image every 0.0001 seconds, 0.0002 seconds, 0.0005 seconds, 0.001 seconds, 0.002 seconds, 0.005 seconds, 0.01 seconds, 0.02 seconds, 0.05 seconds. 0.1 seconds, 0.2 seconds, 0.5 seconds, 1 second, 2 seconds, 5 seconds, or 10 seconds. In some embodiments, the capture rate may change depending on user input and/or external conditions (e.g. illumination brightness).

The imaging device 101 may have adjustable parameters. Under differing parameters, different images may be captured by the imaging device while subject to identical external conditions (e.g., location, lighting). The adjustable parameter may comprise exposure (e.g., exposure time, shutter speed, aperture, film speed), gain, gamma, area of interest, binning/subsampling, pixel clock, offset, triggering, ISO, etc. Parameters related to exposure may control the amount of light that reaches an image sensor in the imaging device. For example, shutter speed may control the amount of time light reaches an image sensor and aperture may control the amount of light that reaches the image sensor in a given time. Parameters related to gain may control the amplification of a signal from the optical sensor. ISO may control the level of sensitivity of the camera to available light. Parameters controlling for exposure and gain may be collectively considered and be referred to herein as EXPO.

In some alternative embodiments, an imaging device may extend beyond a physical imaging device. For example, an imaging device may include any technique that is capable of capturing and/or generating images or video frames. In some embodiments, the imaging device may refer to an algorithm that is capable of processing images obtained from another physical device.

The video data or image data may be transmitted from the movable object to a remote terminal 120. The video data may be transmitted using a communication unit 103 onboard the movable object and received by a communication unit 121 located at the remote terminal 120. One or more communication links 105 may be provided between the movable object and the remote terminal for transmitting the video data. The one or more communication links may be enabled by the communication units 103, 121. In some cases, the communication units 103, 121 are used to establish a communication between the movable object and the remote terminal. In some cases, the communication units are used for video transmission.

In some cases, the communication unit 103 may enable communication with terminal 120 (e.g., control station, remote controller, user terminal, etc) having a communication unit 121 via wireless signals. The communication units 103, 121 may include any number of transmitters, receivers, and/or transceivers suitable for wireless communication. The communication may be one-way communication, such that data can be transmitted in only one direction. For example, one-way communication may involve only the movable object 110 transmitting data to the terminal 120, or vice-versa. The data may be transmitted from one or more transmitters of the communication unit 103 to one or more receivers of the communication unit 121, or vice-versa. Alternatively, the communication may be two-way communication, such that data can be transmitted in both directions between the movable object 110 and the terminal 120. The two-way communication can involve transmitting data from one or more transmitters of the communication unit 103 to one or more receivers of the communication unit 121, and vice-versa.

The communication unit 103 onboard the movable object may be configured to transmit the encoded video data to a communication unit 121 remote from the movable object. The communication unit 121 may or may not be located at a terminal 120. The terminal may or may not be located on the ground. The terminal may be located remotely from the movable object. In some instances, the communication unit 121 may be located at a ground station in communication with the movable object and the terminal. The terminal and the movable object may be in communication with each other via the communication units 103 and 121.

Depending on the direction of the data transmission, the movable object communication links can be generally categorized as uplinks and downlinks. In some cases, an uplink is primarily responsible for the transmission of control data from a control station or a remote control device (e.g., remote terminal 120) to the movable object, for example, to achieve real-time flight attitude control of the UAV and/or command automation. The downlink, in some cases, is primarily responsible for the transmission of video data, telemetry data, image data and other data from the movable object to the control station or remote control device (e.g., remote terminal 120). The video data can be transmitted using the downlink.

The terminal 120 can be a remote control device at a location distant from the movable object 110. The terminal 120 can be used to control any suitable state of the movable object 110. For example, the terminal 120 can be used to control the position (e.g., location and/or orientation) of the movable object using commands or control data transmitted to the movable object 110. The terminal 120 can include a suitable display unit for viewing information of the movable object 110. For example, the terminal 120 can be configured to display information of the movable object 110 with respect to position, translational velocity, translational acceleration, orientation, angular velocity, angular acceleration, or any suitable combinations thereof. In some embodiments, the terminal 120 can display information collected by the movable object 110, such as image data or video data recorded by a camera coupled to the movable object 110. The terminal 120 may be a user terminal that allows a user to view the video or images received from the movable object.

The user terminal may be any type of external device. Examples of user terminals may include, but are not limited to, smartphones/cellphones, tablets, personal digital assistants (PDAs), laptop computers, desktop computers, media content players, video gaming station/system, virtual reality systems, augmented reality systems, wearable devices (e.g., watches, glasses, gloves, headgear (such as hats, helmets, virtual reality headsets, augmented reality headsets, head-mounted devices (HMD), headbands), pendants, armbands, leg bands, shoes, vests), gesture-recognition devices, microphones, any electronic device capable of providing or rendering image data, or any other type of device. The user terminal may be a handheld object. The user terminal may be portable. The user terminal may be carried by a human user. The user terminal may be worn by a human user. In some cases, the user terminal may be located remotely from a human user, and the user can control the user terminal using wireless and/or wired communications. Various examples, and/or characteristics of user terminal are provided in greater detail elsewhere herein.

A user terminal may include one or more processors that may be capable of executing non-transitory computer readable media that may provide instructions for one or more actions. The user terminal may include one or more memory storage devices comprising non-transitory computer readable media including code, logic, or instructions for performing the one or more actions. The user terminal may include software applications that allow the user terminal to communicate with and receive imaging data from a movable object. The user terminal may include a communication unit, which may permit the communications with the movable object. In some instances, the communication unit may include a single communication unit, or multiple communication units. In some instances, the user terminal may be capable of interacting with the movable object using a single communication link or multiple different types of communication links.

The user terminal may include a display (or display device). The display may be a screen. The display may or may not be a touchscreen. The display may be a light-emitting diode (LED) screen, OLED screen, liquid crystal display (LCD) screen, plasma screen, or any other type of screen. The display may be configured to show a graphical user interface (GUI). The GUI may show an image that may permit a user to control actions of the UAV. In some instances, the user may select a target from the image. The target may be a stationary target or a moving target. In other instances, the user may select a direction of travel from the image. The user may select a portion of the image (e.g., point, region, and/or object) to define the target and/or direction. The user may select the target and/or direction by changing the focus and/or direction of the user's gaze point on the screen (e.g., based on eye-tracking of the user's regions of interest). In some cases, the user may select the target and/or direction by moving his or her head in different directions and manners.

A user may touch a portion of the screen. The user may touch the portion of the screen by touching a point on the screen. Alternatively, the user may select a region on a screen from a pre-existing set of regions, or may draw a boundary for a region, a diameter of a region, or specify a portion of the screen in any other way. The user may select the target and/or direction by selecting the portion of the image with aid of a user interactive device (e.g., mouse, joystick, keyboard, trackball, touchpad, button, verbal commands, gesture-recognition, attitude sensor, thermal sensor, touch-capacitive sensors, or any other device). A touchscreen may be configured to detect location of the user's touch, length of touch, pressure of touch, and/or touch motion, whereby each of the aforementioned manner of touch may be indicative of a specific input command from the user.

The image on the display may show a view collected with aid of a payload of the movable object. For instance, an image collected by the imaging device may be shown on the display. This may be considered a first person view (FPV). In some instances, a single imaging device may be provided and a single FPV may be provided. Alternatively, multiple imaging devices having different fields of view may be provided. The views may be toggled between the multiple FPVs, or the multiple FPVs may be shown simultaneously. The multiple FPVs may correspond to (or can be generated by) different imaging devices, which may have different field of views. The image or video collected by the imaging device may comprise any field of view (such as circumferential) that depends on the direction of the imaging device. A user may use the user terminal to select a portion of the image collected by the imaging device to specify a target and/or direction of motion by the movable object.

In another example, the image on the display may show a map that may be generated with aid of information from a payload of the movable object. The map may optionally be generated with aid of multiple imaging devices (e.g., right camera, left camera, or more cameras), which may utilize stereo-mapping techniques. In some instances, the map may be generated based on positional information about the UAV relative to the environment, the imaging device relative to the environment, and/or the UAV relative to the imaging device. Positional information may include posture information, spatial location information, angular velocity, linear velocity, angular acceleration, and/or linear acceleration. The map may be optionally generated with aid of one or more additional sensors, as described in greater detail elsewhere herein. The map may be a two-dimensional map or a three-dimensional map. The views may be toggled between a two-dimensional and a three-dimensional map view, or the two-dimensional and three-dimensional map views may be shown simultaneously. A user may use the user terminal to select a portion of the map to specify a target and/or direction of motion by the movable object. The views may be toggled between one or more FPV and one or more map view, or the one or more FPV and one or more map view may be shown simultaneously. The user may make a selection of a target or direction using any of the views. The portion selected by the user may include the target and/or direction. The user may select the portion using any of the selection techniques as described.

In some embodiments, the image data may be provided in a 3D virtual environment that is displayed on the user terminal (e.g., virtual reality system or augmented reality system). The 3D virtual environment may optionally correspond to a 3D map. The virtual environment may comprise a plurality of points or objects that can be manipulated by a user. The user can manipulate the points or objects through a variety of different actions in the virtual environment. Examples of those actions may include selecting one or more points or objects, drag-and-drop, translate, rotate, spin, push, pull, zoom-in, zoom-out, etc. Any type of movement action of the points or objects in a three-dimensional virtual space may be contemplated. A user may use the user terminal to manipulate the points or objects in the virtual environment to control a flight path of the UAV and/or motion characteristic(s) of the UAV. A user may also use the user terminal to manipulate the points or objects in the virtual environment to control motion characteristic(s) and/or different functions of the imaging device.

For example, in some embodiments, a user may use the user terminal to implement target-pointing flight. The user may select one or more points on an image displayed on the user terminal. The image may be provided in a GUI rendered on the output device of the user terminal. When the user selects the one or more points, the selection may extend to a target associated with that point. In some cases, the selection may extend to a portion of the target. The point may be located on or proximate to the target in the image. The UAV may then fly towards and/or track the target. For example, the UAV may fly to a predetermined distance, position, and/or orientation relative to the target. In some instances, the UAV may track the target by following it at the predetermined distance, position, and/or orientation. The UAV may continue to move towards the target, track the target, or hover at the predetermined distance, position, and/or orientation to the target, until a new target instruction is received at the user terminal. A new target instruction may be received when the user selects another different one or more points on the image. When the user selects the different one or more points, the target selection may switch from the original target to a new target that is associated with the new one or more points. The UAV may then change its flight path and fly towards and/or track the new target.

In some other embodiments, a user may use the user terminal to implement direction-pointing flight. A user may select a point on an image displayed on the user terminal. The image may be provided in a GUI rendered on the output device of the user terminal. When the user selects the point, the selection may extend to a target direction associated with that point. The UAV may then fly in the direction. The UAV may continue to move in the direction until a countermanding condition is detected. For instance, the UAV may fly in the target direction until a new target direction instruction is received at the user terminal. A new target direction instruction may be received when the user selects another different point on the image. When the user selects a different point, the target direction selection may switch from the original direction to a new target direction that is associated with the new point. The UAV may then change its flight path and fly in the new target direction.

The user terminal may be used to control the movement of the movable object, such as the flight of an UAV. The user terminal may permit a user to manually directly control flight of the movable object. Alternatively, a separate device may be provided that may allow a user to manually directly control flight of the movable object. The separate device may or may not be in communication with the user terminal. The flight of the movable object may optionally be fully autonomous or semi-autonomous. The user terminal may optionally be used to control any component of the movable object (e.g., operation of the payload, operation of the carrier, one or more sensors, communications, navigation, landing stand, actuation of one or more components, power supply control, or any other function). Alternatively, a separate device may be used to control one or more components of the movable object. The separate device may or may not be in communication with the user terminal. One or more components may be controlled automatically with aid of one or more processors.

In some instances, a direction of travel of the movable object may be selected by the user. The movable object may travel in the direction selected by the user. The direction may be selected by a user selecting a portion of an image (e.g., in FPV or map view). The movable object may travel in the selected direction until a countermanding instruction is received or when a countermanding condition is realized. For instance, the movable object may automatically travel in the selected direction until a new direction is input, or a new target is input. The movable object may travel in the selected direction until a different flight mode is selected. For instance, the user may take manual control over the flight of the movable object.

The user terminal may be a control station. The control station may comprise mobile or non-mobile devices. The control station may comprise a remote controller. In some cases, the control station may be interchangeably used as the remote controller. A remote controller may be any type of device. The device may be a computer (e.g., personal computer, laptop computer, server), mobile device (e.g., smartphone, cellular phone, tablet, personal digital assistant), or any other type of device. The device may be a network device capable of communicating over a network.

The remote controller may be handheld. The remote controller may accept inputs from a user via any user interactive mechanism. The device may have any type user interactive component, such as a button, mouse, joystick, trackball, touchpad, pen, inertial sensors, image capturing device, motion capture device, microphone, or touchscreen. The control station may comprise a mobile device such as a remote control terminal, as described elsewhere herein. For example, the mobile device may be a smartphone that may be used to control operation of the UAV. The smartphone may receive inputs from a user that may be used to control flight of the UAV. In some instances, the mobile device may receive data from the UAV. For example, the mobile device may include a screen that may display images captured by the UAV. The mobile device may have a display that shows images captured by a camera on the UAV in real-time. One or more mobile devices may be connected to the UAV via a wireless connection (e.g., Wi-Fi) to be able to receive data from the UAV in real-time. For example, the mobile device may show images from the UAV in real-time. In some instances, the mobile device (e.g., mobile phone) can be connected to the UAV and may be in close proximity to the UAV. For example, the mobile device may provide one or more control signals to the UAV. The mobile device may or may not need to be in close proximity to the UAV to send the one or more control signals. The control signals may be provided in real-time. The user may be actively controlling flight of the UAV and may provide flight control signals to the UAV. The mobile device may or may not need to be in close proximity to the UAV to receive data from the UAV. The data may be provided in real-time. Any described about the user terminal can be applied to the control station.

One or more communication links 105 may be provided for transmitting the video data. The one or more communication links may have different working frequency band. Each of the one or more communication links may be wireless link. The wireless link may include a RF (radio frequency) link, a Wi-Fi link, WiMAX link, a Bluetooth link, a 3G link, a LTE link, software defined radio (SDR) based link or any other wireless technology based links. The wireless link may be used for transmission of video or image data over long distances. For example, the wireless link may be used over distances equal to or greater than about 5 m, 10 m, 15 m, 20 m, 25 m, 50 m, 100 m, 150 m, 200 m, 250 m, 300 m, 400 m, 500 m, 750 m, 1000 m, 1250 m, 1500 m, 1750 m, 2000 m, 2500 m, 3000 m, 3500 m, 4000 m, 4500 m, 5000 m, 6000 m, 7000 m, 8000 m, 9000 m, or 10000 m. In some cases, the communication unit 103 may be a component of the imaging device and/or the encoder. For example, the imaging device and/or the encoder may comprise one or more transceivers. In some cases, the communication unit 121 may be a component of a display device coupled to the terminal and/or a decoder.

One or more channel conditions or characteristics across the one or more communication links 105 may or may not be the same. The one or more channel characteristics or conditions may include noise, interference, signal-to-noise ratio (SNR), bit error rate, fading rate or bandwidth. For instance, the bandwidth may or may not be the same across the one or more communication links. The bandwidth of the communication links between the movable object and the user terminal may be in a range from about 10 Kbps to about 1M bps. In other instances, the noise, interference, SNR, bit error rate, fading rate and the like may or may not be the same across the one or more communication links. Communication links differ in one or more of the characteristics may be asymmetric links. The one or more characteristics or channel conditions may change with time. The one or more characteristics or channel conditions may change with respect to the environment of the movable object or location of the movable object.

In some cases, the one or more communication links may or may not use the same techniques or standards such as, coding schemes, modulation schemes, duplexing means or communication protocols. For example, different coding schemes may use different image data compression rate depending on the current or available communication bandwidth of the different communication links. The one or more communication links may be the same type (e.g., Wi-Fi) but may differ in one or more of the channel conditions such as bandwidth. The one or more communication links may be the same type (e.g., Wi-Fi) but may differ in the modulation or coding schemes. Alternatively, various aspects of the communication links may be the same and the communication links may be symmetric.

Any suitable number of communication units (e.g., two, three, four, five, six, or more) can be used to establish a number of communication links. In some instances, one or more of the plurality of communication links may simultaneously be available. Optionally, all of the communication links may simultaneously be available. An available communication link may refer to a communication link that is not disconnected, dropped, or otherwise currently unable of communicating data. In some cases, a plurality of simultaneous communication links such as two or more, three or more, four or more, five or more, six or more, eight or more, ten or more, sixteen or more, or twenty-four or more simultaneous communication links may be provided for transmitting the video data or image data.

In some embodiments, a plurality of communication links or channels are used for transmitting the video data. A video data may be decomposed into a plurality of sub-video data units. In some cases, each sub-video data unit may have the same length as the original video data. For instance, the sub-video data unit may comprise the same number of frames as the original video data. Each frame of the sub-video data unit may be referred to as a sub-image. Alternatively, the number of the sub-images is not equal to the number of frames in the video data. For instance, a sub-video data unit may comprise a sequence of sub-images from a segment of the original video data. The sub-video data may be divided in the time domain and the spatial domain. Each of the available communication links or channels may be used for transmitting a sub-video data unit or a group of sub-video data units. A video data may be decomposed into any number of sub-video data units, such as, two or more, three or more, four or more, five or more, six or more, eight or more, ten or more, sixteen or more, or twenty-four or more. The number of sub-video data units may or may not match the number of communication links. In some cases, the plurality of sub-video data units are divided into groups and the number of groups may match the number of communication links.

In some embodiments, a sub-video data unit may comprise one or more sub-images. The sub-video data unit may comprise one sub-image or successive sub-images. Each of the successive sub-images may be a component of an image from a sequence of images. In some cases, the video data may comprise one or more image frames and each image frame may be decomposed into a plurality of sub-images. The image frame may be spatially decomposed into a plurality of components. The sub-image may comprise a component of the image frame or a transformation of a component of the image frame. For example, each sub-image may comprise a sub-set of the raw pixels from the original image frame. In another example, each sub-image may comprise transformation data of a sub-set of the raw pixels from the original image frame.

The image frame can be decomposed into a plurality of sub-images using various methods. The image frame may be decomposed using spatial sampling method or spatial transformation method. For example, each sub-image may comprise a portion of the pixels of the image frame thus each sub-image is down-sampling of the original image frame. In this case, the plurality of sub-images may have equal characteristics. Each sub-image may represent average information of the original image frame. In another example, an image frame may be decomposed into different components or a set basis functions by applying a transformation on the image frame. The transformation may provide localization in both space and spatial frequency. Each sub-image may comprise one or more transformation coefficients or a component of transformation result. The transformation operation may be selected such that most of the energy in the image may be contained in a few large transform coefficients. In this case, the plurality of sub-images may have unequal characteristics according to the different energy concentration. The energy of a pixel may be defined as the square of its value times some scaling factor. Similarly, the energy of a transform coefficient may be defined as the square of its value times some scaling factor. With the proper scaling factor, the total energy of the pixels in a picture will always equal the total energy in the transform coefficients.

Various types of transforms can be used for decomposing the image frame. A transform of image may define a set of basis functions and the set of basis functions may or may not be orthogonal. In some cases, the number of coefficients produced may be equal to the number of pixels transformed. In some cases, the transforms may be selected such that energy of the transformed image frame or the coefficients may be concentrated in a few coefficients or component of the transformed image. For example, the transform process may concentrate the energy into particular coefficients, generally the low frequency ones. The sub-image comprises the coefficients with the concentrated energy or transformed result may be prioritized for data transmission over other sub-images.

Various types of transforms can be used for decomposing the image frame. Different types of transforms may have different degree of concentration of energy. Different types of transforms may differ in the region of influence of each coefficient in the reconstructed image frame. The transforms used for decomposing the image frame may be, for example, Fourier transforms (discrete Fourier transforms) or orthogonal transforms. The transforms can be any type of transforms selected from the group including, but not limited to, Hadamard transformation, discrete cosine transformation discrete, Fourier transformation, Walsh-Hadamard transformation, Haar transformation, or Slant transformation.

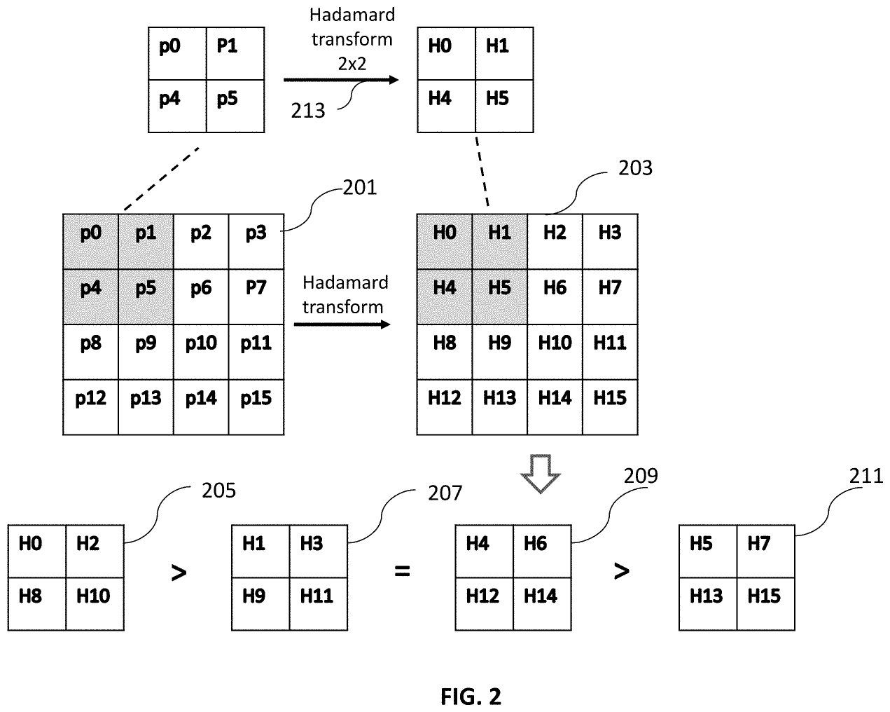

FIG. 2 shows an example of decomposing of an image frame 201 using spatial transformation method, in accordance with embodiments. In this example, a Hadamard transform is used to decompose the image frame 201 into a plurality of sub-images 205, 207, 209, 211. Sub-image and sub-frame may be interchangeably used throughout the description. The image frame 201 as described elsewhere herein may comprise a number of rows and columns or groups of pixels. In some cases, the number of the sub-images may be equal to the number of sub-video data units. For instance, each sub-video data unit may have the same length (number of frames or in seconds) as the original video data. The video data may be divided in the spatial domain. Alternatively, the number of the sub-images is not equal to the number of sub-video data units. For instance, a sub-video data unit may comprise a sequence of sub-images from a segment of the original video data. The sub-video data may be divided in the time domain and the spatial domain. In some instances, the number of sub-images may be determined by the dimension of the transformation matrix or the block size for performing the transformation.

As shown in FIG. 2, a 2×2 Hadamard transformation matrix 213

$$H = [ \begin{matrix}1 & 1 \\ 1 & - 1\end{matrix} ]$$

may be applied to a 2×2 block of the image frame. In this example, after transformation,

H0=p0+p1+p4+p5

H1=p0+p1−p4−p5

H4=p0+p4−p1−p5

H5=p0+p5−p1−p4

where p0, 1, 4, 5 represent pixels from the original image frame and H0, H1, H4, H5 represent data in the sub-image. The number of the transformation coefficients may be the same as the number of pixels processed in the original image (e.g., 2×2). In some cases, the transform coefficients may be further processed such as roundup or thresholding. Each of the plurality of sub-images may comprise a sub-set of the transform coefficients or the transform result data 203.

The plurality of sub-images may differ in energy concentration as described previously. In some instances, the sub-images 205, 207, 209, 211 may be ordered or prioritized according to the energy concentration. For instance, the sub-image comprises the low frequency information (e.g., the sub-image 205) may be prioritized over the rest of the sub-images. The four sub-images may be ordered or prioritized as illustrated in FIG. 2. For instance, the priority from high to low is sub-image 205>sub-image 207=sub-image 209>sub-image 211.

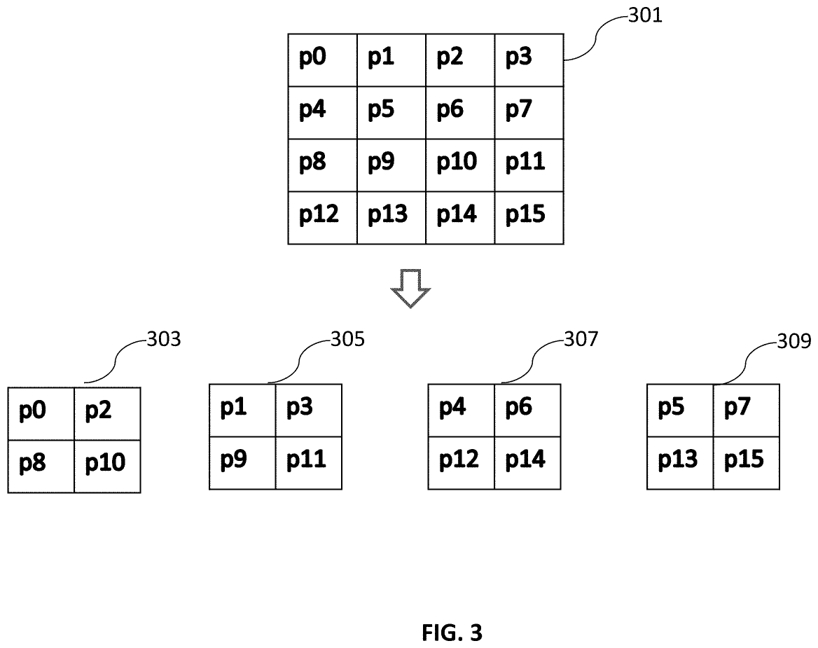

In some embodiments, an image frame may be decomposed into a plurality of sub-images with substantially similar characteristics. The image frame may be decomposed using a spatial sampling method. The plurality of sub-images may have equal priority. FIG. 3 shows an example of decomposition method, in accordance with embodiments. As shown in FIG. 3, an image frame 301 may be decomposed into a plurality of sub-images 303, 305, 307, 309. The image frame can be decomposed into any number of sub-images. Each sub-image may comprise a sub-set of the pixels. Each sub-image may be a down-sampling of the image frame 301. In some cases, the neighboring pixels of the original image frame may be comprised by different sub-images. In the example as illustrated in the figure, each sub-image may comprise pixels with coordinate from the original image frame as following:

sub-image 303 comprises pixel with coordinate (2i, 2j) from image frame 301;

sub-image 305 comprises pixel with coordinate (2i, 2j+1) from image frame 301;

sub-image 307 comprises pixel with coordinate (2i+1, 2j) from image frame 301;

sub-image 309 comprises pixel with coordinate (2i+1, 2j+1) from image frame 301,

where i and j represent the row and column index respectively.

A sub-video data unit may comprise one or more sub-images. The plurality of sub-video data units may be encoded individually. The plurality of sub-video data units may be encoded by one or more encoders in parallel. In some instances, two or more sub-video data units may be encoded by the same encoder sequentially. Various coding schemes or video compression standards can be used. In some cases, a motion-compensation-based video compression standard such as the H.263, H.264, H.265, MPEG-4 AVC standard can be used for encoding the sub-video data. Various coding methods such as entropy coding tools including Huffman coding, run-level coding, and arithmetic coding may be used.

In some case, the plurality of encoded sub-video data units may be prioritized according to one or more characteristics of the coded sub-video data unit. The one or more characteristics may include, but not limited to, priority of the sub-images according to the energy concentration, the size of the coded sub-video data. The size of a coded sub-video data unit may include the bitrate (bit per second) of the coded sub-video data unit or the storage size (bitrate*length) of the coded sub-video data unit. In some cases, the plurality of encoded sub-video data units may be prioritized according to the size or the bitrate of the coded sub-video data unit and the transmission capability (e.g., bandwidth) of the available communication link. For instance, a coded sub-video data unit having a greater bitrate or a greater storage size may be transmitted using a communication link with greater bandwidth (bit per second) such that the bitrate or storage size may match the bandwidth of the selected communication link. In some cases, the encoding techniques or parameters may be selected based on the priority such that more information may be preserved for the high priority sub-images. For instance, the sub-images may be encoded at different data compression ratio that the higher priority (e.g., sub-image 205) may be compressed less than the lower priority sub-images. Conversely, the encoder may choose a quantization step such as a higher quantization step so as to counteract the increase of the bitrate that would otherwise be caused by the high energy concentration. In some cases, bits allocation and/or quantization steps for encoding may be determined according to the priority among the plurality of sub-images. For instance, more bits may be allocated to the sub-image with high priority. Alternatively, encoding methods or parameters may be selected such that the plurality of encoded sub-video data units may have similar size or the reconstructed image has a uniform quality.

In some cases, the plurality of encoded sub-video data units may have equal priority. The encoded sub-video data units may have substantially similar characteristics. For instance, when the original image frame is decomposed using the down-sampling method, the encoded sub-video data units may be encoded using the same coding schemes and parameters. The encoding methods or parameters may be selected such that the plurality of encoded sub-video data units may have similar size or the reconstructed image has a uniform quality

In some embodiments, a plurality of communication links or channels may be available for transmitting the video data (e.g., multi-link transmission). The plurality of communication links or channels may be allocated and assigned to transmit plurality of sub-video data units simultaneously. The plurality of sub-video data units may be generated using the methods as described above. The plurality of sub-video data units may or may not have equal characteristics. The plurality of communication links or channels may be allocated to the plurality of sub-video data units according to one or more characteristics or conditions of the channels and one or more characteristics of the sub-video data units. In some embodiments, at least one of the plurality of coded sub-video data units is selected for transmission according to one or more characteristics the sub-video data units and one or more channel conditions of a plurality of channels. The characteristics or conditions of the channels or communication links may include, but not limited to, noise, interference, signal-to-noise ratio (SNR), bit error rate, fading rate or bandwidth. The characteristics of the sub-video data units may include but not limited to, size of the coded sub-video data unit or bitrate of the coded sub-video data unit, priority of the sub-video data based on energy concentration or other factors.

In some instances, the plurality of communication links may be allocated and assigned to the plurality of sub-video data units according to the priority of the sub-video data unit. For example, channels or communication links with low noise level, less interference, high signal-to-noise ratio (SNR), or low fading rate may be assigned to the high priority sub-video data units.

In some instances, at least one of the plurality of coded sub-video data units is selected for transmission according to the priority of the sub-video data unit. For example, high priority sub-video data units may be selected to be transmitted using channels or communication links with good channel conditions.

In some instances, the plurality of communication links or the coded sub-video data units may be selected based on the capability of the channel and the size of the coded sub-video data unit or the bitrate of the coded sub-video data unit. For instance, a communication link or channel with broader bandwidth may be assigned to the coded sub-video data unit with greater bitrate.

In some embodiments, the plurality of coded sub-video data units may be selected or organized to be adapted for a change in the channel conditions. The change in the channel conditions may be, for instance the number of available channels or the transmission capability of a channel. The method may provide a dynamic allocation of the sub-video data to be adapted for a change in the channel conditions at sub-frame/sub-image level.

In some instances, the plurality of coded sub-video data units may be grouped into a number of groups to be adapted for the transmission capability of the plurality of communication links. The coded sub-video data units may be grouped so as to best utilize the bandwidth of the communication link. For instance, the total bitrate (bit per second) of the group of coded sub-video data units or the storage size of the group of the coded sub-video data units (bitrate * length) may match the bandwidth of a selected communication link (bit per second).

In some cases, the plurality of coded sub-video data units may be grouped dynamically to be adapted for a change in the transmission capability. For instance, when the bandwidth of one or more of the communication links changes, the plurality of coded sub-video data units may be re-grouped and organized to match the current bandwidth.

In some instances, the plurality of coded sub-video data units may be prioritized and selected for transmission based on the number of available channels. For example, when the available communication links are limited and not all of the sub-video data units can be transmitted simultaneously, sub-video data units with high priority may be selected for transmission and low priority sub-video data may be discarded.

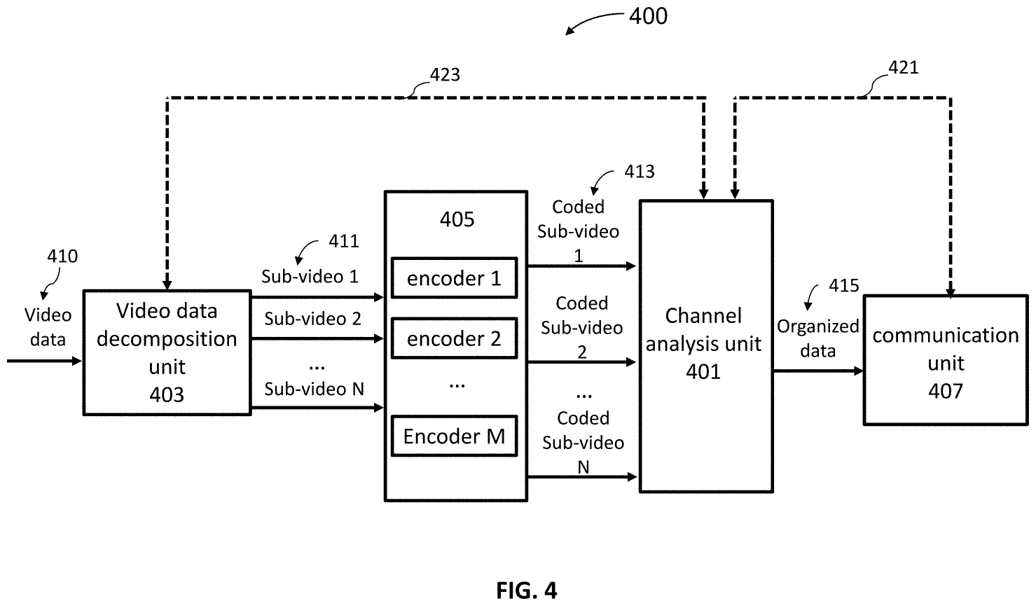

FIG. 4 shows a block diagram 400 illustrating examples of components for processing image or video data and transmitting the video data, in accordance with embodiments. The components may provide a live streaming of video data with low latency. The components may provide an adaptive video transmission with reduced latency and improved resilience to transmission error. The components may be provided onboard a movable object and the video data may be wireless transmitted to a remote terminal. The components may be configured to dynamically assign a plurality of sub-video data units to multiple communication links for transmission. The movable object may be a UAV.

The video data 410 may be captured by one or more imaging device (not shown) as described elsewhere herein. The imaging device may be carried by the movable object. The imaging device may be operably coupled to the movable object via a carrier. Optionally, the imaging device may be disposed within a housing of the movable object. In some alternative embodiments, the imaging device may be implemented as a stand-alone device and need not be provided on a movable object. The image data or video data 410 may be transmitted to a video data decomposition unit 403 and decomposed into a plurality of sub-video data units 411. The video data decomposition unit 403 may be provided onboard the movable object or remote to the movable object. The video data decomposition unit may be implemented using one or more processors onboard the movable object or remote to the movable object. The video data decomposition unit may be implemented using software, hardware or a combination of both. The plurality of sub-video data units 411 may be encoded by one or more encoders 405. The one or more encoders 405 may be implemented using one or more processors. The one or more encoders may be implemented using software, hardware or a combination of both. The one or more processors onboard the movable object may include video codec processors for encoding the plurality of sub-video data units 411 in parallel. The encoder as used herein may include a video encoder. The coded sub-video data units 413 may be selected and/or organized for transmission by a channel analysis unit 401. The channel analysis unit 401 may be configured to organize the plurality of sub-video data units into groups and allocate one or more communication links or channels for transmitting the groups of organized data 415. The channel analysis unit may determine the channel/sub-video data allocation according to real-time channel conditions and characteristics of the sub-video data unit. In some cases, the channel analysis unit 401 may be configured to assess the channel conditions or characteristics in real-time. The channel analysis unit may be implemented using one or more processors. The one or more processors may or may not be part of the communication unit. The channel analysis unit, one or more encoders, or the video decomposition unit may or may not be implemented using the same processors. In some instances, two or more of the components as described above may be implemented using the same processors. Alternatively, the plurality of components may be separate devices. The communication unit 407 may be located within a body of the movable object. The communication unit 407 may include one or more transmitters configured to transmit the organized data 415 from the movable object directly or indirectly to the remote terminal.

In some embodiments, the imaging device, video data decomposition unit 403, encoder(s) 405, channel analysis unit 401 and the communication unit 407 may be mounted or co-located on the movable object, such as a vehicle that is capable of traveling in the air, on land, on water, or within a water body. Examples of vehicles may include an aerial vehicle (e.g., UAVs, airplanes, rotor-craft, lighter-than air vehicles), a land-bound vehicle (e.g., cars, trucks, buses, trains, rovers, subways), a water-bound vehicle (e.g., boats, ships, submarines), or space-based vehicles (e.g., satellites, shuttles, rockets). A movable object may be capable of traversing on land or underground, on or in the water, within the air, within space, or any combination thereof. In some embodiments, the movable object may be a mobile device, a cell phone or smartphone, a personal digital assistant (PDA), a computer, a laptop, a tablet PC, a media content player, a video game station/system, wearable devices such as a virtual reality headset or a head mounted device (HMD), or any electronic device capable of capturing, providing or rendering image data, and/or identifying or tracking a target object based on the image data. The movable object may be self-propelled, can be stationary or moving, and may change orientation (e.g., attitude) over time.

As shown in FIG. 4, the raw image data or video data 410 may be transmitted to the video data decomposition unit 403. The video data decomposition unit may be a stand-alone device borne by the movable object or a component of the imaging device or a component of the encoder. In some embodiments, the raw video data may comprise a plurality of color images, and the plurality of pixels may comprise color pixels. In other embodiments, the raw image data and the encoded video data may comprise a plurality of grayscale images, and the plurality of pixels may comprise grayscale pixels. In some embodiments, each pixel in the plurality of grayscale images may have a normalized grayscale value.

The video data decomposition unit 403 may decompose the video data into a plurality of sub-video data units 411 (N=2, 3, 4, 5, 6, 7, 8, 9, 10, 11, 12, 13, 14, 15, 16, etc). The number of sub-video data units may be greater than or equal to the number of communication links. Various decomposition methods such as spatial transformation or spatial down-sampling may be implemented by the video data decomposition unit. Depending on the decomposition methods, the plurality of sub-video data units may or may not have similar characteristics (e.g., energy concentration) or equal priorities. A sub-video data unit may comprise one or more sub-images. A sub-video data unit may comprise one sub-image or successive or sequential sub-images. The one or more sub-images may each from an image frame of the original video data. In some instances, each sub-video data unit may have the same length (number of frames) as the original video data. The video data may be decomposed in the spatial domain. Alternatively, a sub-video data unit may comprise a sequence of sub-images from a segment of the original video data. The sub-video data may be divided in the time domain and the spatial domain. When the original video data is divided into segments temporally, the plurality of sub-video data units may comprise sub-images from the same segment.

The plurality of sub-video data units 411 may not be substantially similar to one another. In some cases, the plurality of sub-video data units may differ in terms of energy concentration. For instance, each sub-image of the sub-video data unit may comprise transformation coefficients of the corresponding sub-set of pixels and the sub-image comprises the low frequency coefficients may have concentrated energy. The plurality of sub-video data units may be prioritized according to the energy concentration. Alternatively, the plurality of sub-video data units may be substantially similar to one another or have equal priorities. For example, a sub-video data unit is a down-sampling of the original image frame and each sub-image frame comprises a subset of pixels representing average properties of the original image frame.

As shown in FIG. 4, the plurality of sub-video data units 411 may be transmitted to the one or more encoders 405 to be processed (encoded) into coded sub-video data units 413. The one or more encoders may be stand-alone device borne by the movable object or a component of the imaging device. Optionally, the one or more encoders may be off-board the UAV. In some instances, the one or more encoders may encode the plurality of sub-video data units in parallel. In some instances, two or more sub-video data units may be encoded by the same encoder sequentially.

Each sub-video data unit may be encoded individually. Each sub-video data unit may be encoded without reference information from other sub-video data units. As described elsewhere herein, the encoders may or may not employ the same coding schemes or parameters. In some cases, the encoders may use different coding schemes or parameters when the sub-video data units are different. In some cases, same coding schemes or parameters may be used regardless of difference across the plurality of sub-video data units.

The one or more encoders may be configured to compress the digital signals in the sub-video data units, in an attempt to reduce the size of the data without significant adverse effects on the perceived quality of the image. The data compression may comprise image compression and/or video compression. The data compression may include encoding information using fewer bits than the original format. The data compression can be lossy or lossless. Lossless compression may reduce bits by identifying and eliminating statistical redundancy. No information is lost in lossless compression. Lossy compression may reduce bits by identifying certain information and removing/truncating it. This data compression is especially advantageous when the bandwidth for data transmission between the movable object and a user terminal is limited.

In some cases, method or parameters across the plurality of encoders may be selected according to the size of the sub-video data unit. The video compression method may or may not require inter frame information. In some cases, when the sub-video data unit comprises a single sub-image, the compression algorithm may be applied to the single sub-image without inter frame information. For example, JPEG image compression may round off nonessential bits of information to obtain trade-off between preserving information and reducing size within an image frame without referencing information from previous or successive image frames. Alternatively, the video compression may require inter frame information encoding such as temporal compression or motion based compression. For example, MPEG compression may further add inter-frame encoding to take advantage of the similarity of consecutive frames in a motion sequence.

In some cases, method or parameters across the plurality of encoders may be selected such that the reconstructed image frame may have a uniform compression quality. The compression quality may include a quantization parameter (QP) value which is achieved by compressing a range of values to a single quantum value. For example, QP value may be used to reduce the number of colors used in an image. QP value may also be used to reduce the information from high frequency components of image data. In some instances, a higher QP value may indicate a higher compression rate applied to the image data which results in bigger data loss, and a lower QP value may indicate a lower compression rate applied to the image data which results in smaller data loss. After compression, the image data compressed using a higher QP value may have lower resolution, lower brightness, lower contrast, less detailed color information, and/or losing other image qualities. On the other hand, the image data compressed using a lower QP value may have higher resolution, higher image brightness, higher image contrast, more detailed color information, and/or other enhanced image qualities. Other suitable compression methods and algorithms may also be used.

The plurality of coded sub-video data units 413 may be organized and assigned to one or more communication links by the channel analysis unit 401. In some embodiments, the channel analysis unit may selectively group the plurality of coded sub-video data units into one or more groups. The plurality of coded sub-video data units may be grouped into a number of groups to be adapted for the transmission capability of the plurality of communication links. In some cases, the coded sub-video data units may be grouped so as to best utilize the bandwidth of the communication link. For instance, the channel analysis unit may select one or more coded sub-video data units to be grouped together, such that the total bitrate (bit per second) of the group of coded sub-video data units or the storage size of the group of the coded sub-video data units (bitrate * length) may match the bandwidth of a selected communication link (bit per second). The coded sub-video data units in the same group may be transmitted using a communication link or channel concurrently. In some cases, the number of groups may be equal to the number of available communication links or channels.

In some embodiments, the channel analysis unit 401 may be configured to allocate channels or communication links with different channel conditions for transmitting the coded sub-video data unit based on priority (e.g., energy concentration). For example, channels or communication links with low noise level, less interference, high signal-to-noise ratio (SNR), or low fading rate may be assigned to the high priority sub-video data units.

The channel analysis unit 401 may organize or group the coded sub-video data units into organized data 415 for transmission. The organized data may be transmitted by one or more communication links or channels enabled by the communication unit 407. The organized data 415 may comprise a number of groups and each group may be transmitted using a communication link. A group may comprise one or more coded sub-video data units. The one or more groups may be assigned to the one or more communication links according to one or more channel characteristics including but not limited to, noise, interference, signal-to-noise ratio (SNR), bit error rate, fading rate or bandwidth. The communication unit 407 can be the same as the communication unit 103 as described in FIG. 1.

The video data may be transmitted using the communication unit 407 onboard the movable object and received by a communication unit located at a remote terminal. One or more communication links or channels may be provided between the movable object and the remote terminal for transmitting the video data. The one or more communication links or channels may be enabled by the communication unit 407. In some cases, the communication unit 407 is used to establish a communication between the movable object and the remote terminal. In some cases, the communication unit is used for video transmission. In some cases, the communication unit 407 may enable communication with a terminal (e.g., control station, remote controller, user terminal, etc) via wireless signals. The communication unit may include any number of transmitters, receivers, and/or transceivers suitable for wireless communication. The communication may be one-way communication, such that data can be transmitted in only one direction. For example, one-way communication may involve only the movable object transmitting data to the terminal, or vice-versa. The data may be transmitted from one or more transmitters of the communication unit 407 to one or more receivers of the terminal, or vice-versa. Alternatively, the communication may be two-way communication, such that data can be transmitted in both directions between the movable object and the terminal. The two-way communication can involve transmitting data from one or more transmitters of the communication unit 407 to one or more receivers of the terminal, and vice-versa. Any description about the communication unit and channels as described elsewhere herein can be applied to the communication unit 407 and the one or more channels or communication links enabled by the communication unit.

In some embodiments, the one or more channel characteristics may be measured or estimated by the channel analysis unit 401. In some cases, the channel analysis unit may be configured to measure the one or more characteristics or conditions 421. The conditions or characteristics can be measured using various methods such as using measurement subframes. The channel conditions or characteristics may be measured, e.g., in real time or at set intervals. For example, the channel conditions or characteristics may be measured at about or less than every 0.001 seconds, 0.002 seconds, 0.005 seconds, 0.01 seconds, 0.02 seconds, 0.05 seconds, 0.1 seconds, 0.2 seconds, 0.5 seconds, 1 second, 2 seconds, 5 seconds, 10 seconds, 30 seconds, 60 seconds, 5 minutes, or 10 minutes. In some cases, one or more of the channel conditions or characteristics may be known to the channel analysis unit and such characteristics may not be measured dynamically or in real-time.

In some embodiments, the channel analysis unit is 401 in communication with the video data decomposition unit 403. In some instances, according to the channel characteristics, conditions or number of available channels, the channel analysis unit may generate an instruction indicating how the video data may be decomposed. In some instances, information 423 related to the channel characteristics, conditions or number of available channels may be provided to the video data decomposition unit to determine how the video data may be decomposed. In some case, the information may be indicative of symmetry or asymmetry of the multiple links. In some cases, the information may include the number of available communication links or channels. For instance, if the multiple channels have similar or symmetric characteristics, spatial sampling method may be selected for decomposing the image frame such that the plurality of sub-video data units have equal priorities. In another instance, if the multiple channels have asymmetric characteristics, spatial transformation method (e.g., Hadamard transform) may be selected such that the sub-video data units have unequal priorities. In other instances, when limited communication links are available, the decomposition method (e.g., Hadamard transform) may be selected such that sub-video data units have higher priority over others (e.g., high energy concentration) may be transmitted using the available communication links.

The provided method or system may be beneficial to provide an adaptive switch between the symmetric and asymmetric multi-link conditions, or between the multi-link and single-link conditions. The decomposition method may be selected in response to the information or instruction provided by the channel analysis unit 401. The decomposition method may be selected or changed during image capturing or prior to image capturing. The decomposition method may be selected or changed dynamically to be adapted for the real-time channel conditions.

In some case, the information indicative of symmetry or asymmetry of the multiple links may be estimated information. The symmetry or asymmetry of the multiple links may be estimated by checking a signal strength or a location (e.g., GPS location) of the movable object. The location of the movable object may be provided by the location sensor of the movable object as described elsewhere herein. In some cases, the asymmetry of the multiple links may be estimated based on the environment of the radio communication. The symmetry or asymmetry information may be obtained by detecting a location of the movable object or the environment of the movable object. The environment may include objects or topographies and various other factors (e.g., weather) that may affect radio signal propagation. The environment may comprise any structures or factors that may affect, for example, noise, fading, reflection or other characteristics of radio signal propagation. Different environment may result in asymmetry of communication links. For instance, in a cluttered or urban environment, the communication links may tend to be asymmetric such as due to the reflected propagation path cancelling the direct propagation path or different communication links may experience different propagation delay. In another instance, the communication links may tend to be symmetric in less cluttered environment. In this way, by detecting an environment of the radio propagation of the GPS location of the movable object, the symmetry or asymmetry of the multiple links can be estimated instantly. Alternatively, the information related to the channel characteristics, conditions or number of available channels may be measured. In some cases, the symmetry or asymmetry may be estimated by detecting a signal strength and/or round-trip time of a radio signal.

In some embodiments, a method for transmitting video from a movable object using multiple communication links may be provided. The method may comprise: decomposing a video data into a plurality of sub-video data units, where each sub-video data unit comprises one or more sub-images; encoding the plurality of sub-video data units individually; and select at least one of the plurality of coded sub-video data units for transmission according to one or more characteristics the sub-video data units and one or more channel conditions of a plurality of channels. The plurality of coded sub-video data units may be received and decoded individually and are used to reconstruct the original video data.

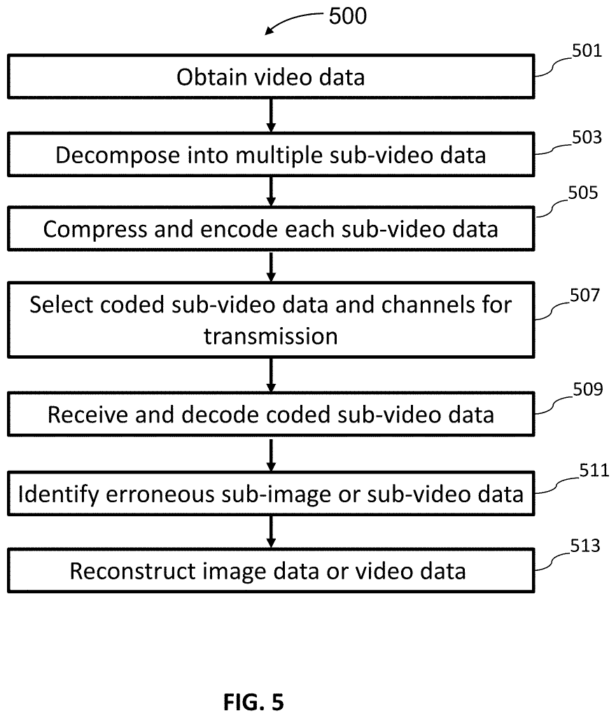

FIG. 5 shows an exemplary process 500 of transmitting video data with reduced latency. The method may be provided for video streaming or video transmission with reduced latency by dynamically allocating the video data to the communication links at sub-frame level. The method may be provided for video streaming or video transmission with improved resilience to transmission errors. Error propagation within the same image frame or successive image frames can be prevented by reconstructing the image frame using correctly received sub-video data.

As illustrated in FIG. 5, video data or image data may be captured by an imaging device 501. The imaging device may be carried by a movable object as described elsewhere herein. In some embodiments, the movable object may be a UAV. The imaging device may be operably coupled to the movable object via a carrier such as a multi-axis gimbal. The video data may be decomposed into a plurality of sub-video data units 503. The image frame of the video may be spatially decomposed into a plurality of sub-images. The plurality of sub-images may or may not be unequal based on energy concentration. In some instances, when spatial transformation method (e.g., Fourier related transformation or orthogonal transformation) used for decomposing the image frame, the plurality of sub-images may be prioritized based on energy concentration. In some instances, when the image frame is decomposed using down-sampling method, the plurality of sub-images may have equal priority. The sub-video data unit may comprise one or more sub-images that each sub-image may be one of the plurality of sub-images comprised by an image frame of the video data. In some cases, each sub-image may comprise a portion of the image frame such as a sub-set of pixels of the image frame. In some cases, each sub-image comprises a plurality of transformation coefficients of the sub-set of pixels of the image frame.

Next, the plurality of sub-video data units may be encoded individually 505. The plurality of sub-video data units may be encoded in parallel by one or more encoders. The coded sub-video data units may or may not have equal size. The coded sub-video data units may or may not have equal priority. The coded sub-video data units may be selected and organized to be transmitted using multiple channels or communication links 507. In some cases, the coded sub-video data units may be selected and assigned to different channels according to the priority of the coded sub-video data such that high energy concentrated sub-video data unit may be transmitted using the high quality channel. In some instances, channels or communication links with good condition may be selected for transmitting the high priority sub-video data. In some cases, the coded sub-video data units may be divided into a number of groups that the group number may be equal to the number of the available communication links. One or more coded sub-video data units may be grouped together to best utilize transmission capability (e.g., bandwidth) of a channel. In some cases, when the transmission capability is limited or the number of links is less than the number of groups, sub-video data with high priority may be selected for transmission or at least one of the down-sampling sub-video data unit may be selected for transmission.

On or more of the coded sub-video data units may be received by a receiver of a remote terminal 509. The coded sub-video data units may be decoded using method associated with the coding scheme used for each sub-video data unit. The sub-video data units may be decoded in substantially real-time. The sub-video data units may be decoded individually. The decoding method or schemes may be pre-known to the receiver. Before reconstructing the image or video data, erroneous sub-video data or sub-images may be identified 511.

The erroneous sub-images or sub-video data may be identified by detecting a transmission error. A transmission error may include random bit errors, long burst errors, packet loss, excessive delays that may be caused by possibly link downs or network congestion. Transmission error may be detected based on the specific transmission protocol, channel coding methods or various other factors. For example, transmission error may be detected by checking the redundancy bits compressed with the source bits (e.g., forward error correction). In another example, a transmission error may be detected when the round-trip time (RTT) exceeds certain value. The transmission error may be detected for one or more sub-images or one or more sub-video data units. In some cases, when an erroneous sub-image or sub-video data unit is identified, such data may not be used for reconstruction of the image frame.

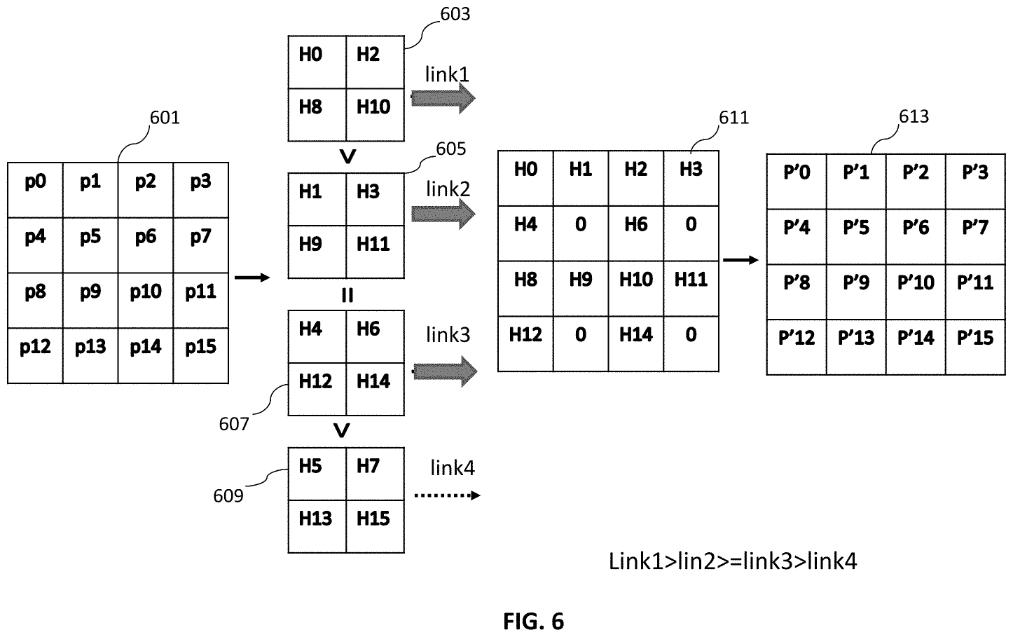

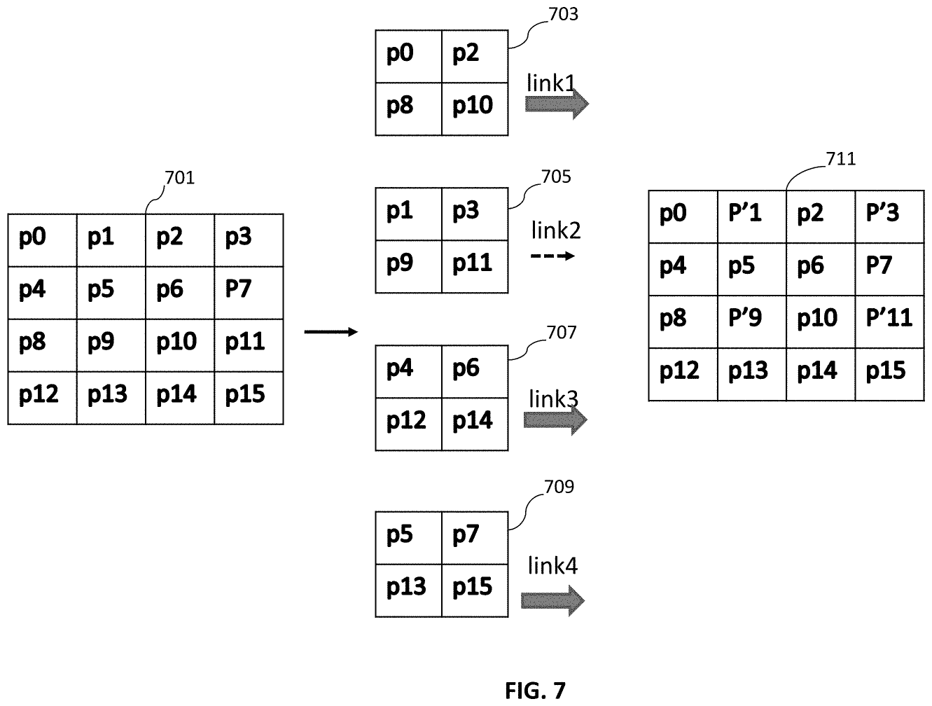

In some embodiments, the image data or video data may be reconstructed based on correctly received sub-video data or sub-images 513. The correctly received sub-video data or sub-images may be the data that without transmission error. The image data or video data may be reconstructed using the correctly received sub-video data and a value assigned to the erroneous sub-video data. The erroneous sub-images or sub-video data may be replaced by a value. The value may be a pre-determined value such as zero. The value may be generated using the correctly received sub-images or sub-video data that are from the same original image frame as the erroneous sub-image. FIGS. 6 and 7 show examples of reconstructing image frame or video data using correctly received sub-video data.

As illustrated in FIG. 6, an image frame 601 may be decomposed into a plurality of sub-images 603, 605, 607, 609. In this example, Hadamard transformation may be used for decomposing the image frame and the plurality of sub-images may have unequal priority. For instance, the plurality of sub-images may be prioritized according to energy concentration. Assuming sub-image 603 contains the low frequency coefficients and the priority of the sub-images is indicated in the figure. A plurality of links (e.g., link 1, link 2, link 3, and link 4) may be available for transmission. The plurality of links may have asymmetric characteristics. For instance, channel condition of the links may differ and thus the link with better reliability (e.g., link 1) may be allocated to transmit the high priority sub-image 603 and the link with poor quality or condition (e.g., link 4) may be assigned to less priority sub-image 609 (contains high frequency coefficients). In the case that transmission error occurs, for instance, sub-image 609 or the associated sub-video data transmitted via link 4 may experience a transmission error, sub-image 609 may be identified as the erroneous sub-image. In this example, zero may be assigned to replace the data comprised by the erroneous sub-image as shown in 611. The rest of the correctly received and decoded sub-images or sub-video data along the replaced erroneous sub-image may be used for reconstructing the image frame 613. For example, inverse Hadamard transform may be applied to the decoded data 611 to reconstruct the image frame 613. Using this method an image frame may be reconstructed or obtained by preserving the significant information (e.g., sub-images with concentrated energy) without significantly influenced by the loss of the high frequency information (sub-image 609).

FIG. 7 illustrates another example of reconstructing an image frame. An image frame 701 may be decomposed into a plurality of sub-images 703, 705, 707, 709. In this example, spatial down-sampling method may be used for decomposing the image frame and the plurality of sub-images may have equal priorities. A plurality of links (e.g., link 1, link 2, link 3, and link 4) may be available for transmission. The plurality of links may have symmetric characteristics or channel conditions. The plurality of sub-video data units may be randomly assigned to the plurality of links. In the case when one or more of the sub-images or sub-video data (e.g., sub-image 705) experience a transmission error (e.g., link 2 is down), the sub-image 705 may be identified as the erroneous sub-image. The erroneous sub-image may not be used for reconstructing the image frame 711. In some cases, a value may be assigned to replace the erroneous sub-image for reconstructing the image frame 711. The value may be obtained by interpolation using neighboring pixels from correctly transmitted sub-images. For instance, P′1 may be a value calculated as interpolation of the neighboring pixels (e.g., p0, p2 p5). The interpolation may be linear or non-linear. The reconstruction of the image frame may not be significantly influenced by the loss of an erroneous sub-image as the reconstructed image frame represents average information of the original image frame (i.e., down-sampling).

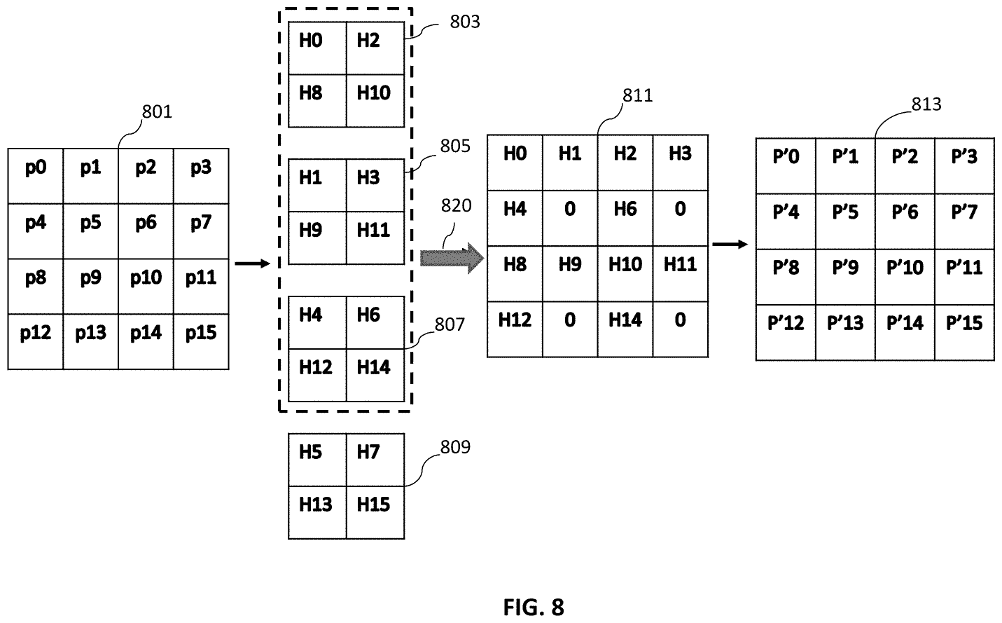

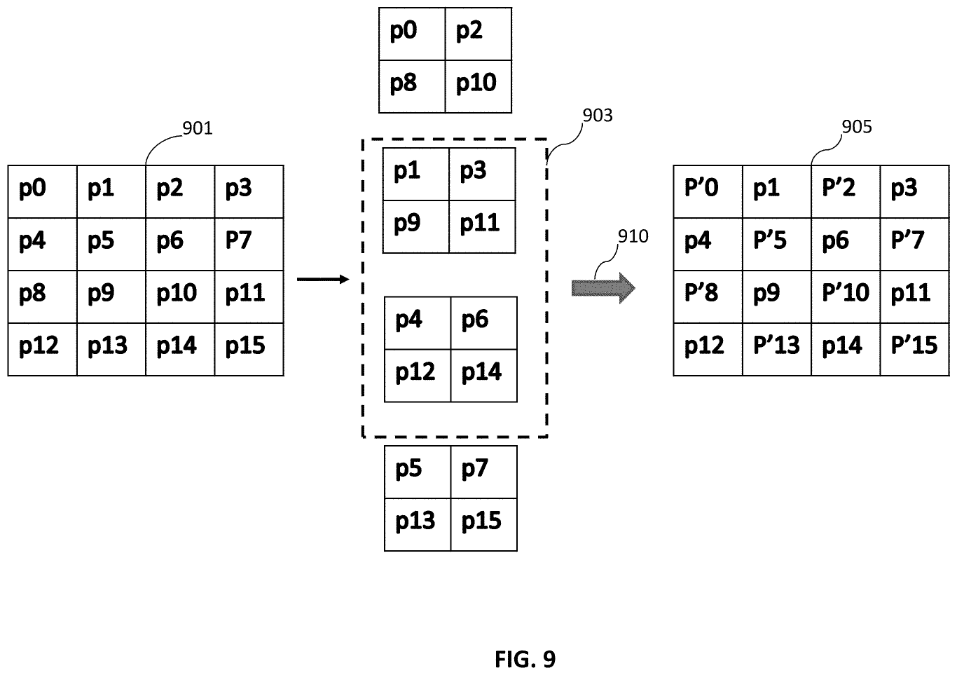

In some cases, the number of available communication links may change along with time. In some cases, the channel condition of the available communication links may change along with time. One or more of the plurality of sub-video data units may be dynamically grouped together or selected to be adapted for the change in the availability of channels or communication links. This may provide an adaptive allocation of channels or video data at sub-frame level. FIGS. 8 and 9 show some examples of adaptive transmission of video data, in accordance with embodiments.

As illustrated in FIG. 8, an image frame 801 may be decomposed into a plurality of unequal sub-images (e.g., Hadamard transform) and the plurality of sub-images may be encoded individually 803, 805, 807, 809. In this example, there is limited number of communication links available for transmission. For instance only a single link transmission 820 may be available. One or more of the plurality of coded sub-images or sub-video data units (e.g., 803, 805, 807) may be selected for transmission using the single link. In some cases, the selection may be based on the priority of the sub-image or the sub-video data. For instance, (coded) sub-video units 803, 805, 807 may be prioritized over (coded) sub-video data unit 809. In some cases, the selection may also take into account the size or bitrate of the coded sub-video data unit and the transmission capability (e.g., bandwidth) of the available communication link. In this example, the less prioritized (coded) sub-video data unit 809 may not be transmitted and zero may be assigned to replace the data comprised by the sub-video data unit as shown in 811. Next the image data or video data may be reconstructed by applying an inverse transformation to the transmitted data as shown in 813.

As illustrated in FIG. 9, an image frame 901 may be decomposed into a plurality of equal sub-images (e.g., spatial down-sampling). The plurality of sub-images may be encoded individually. In this example, there is limited number of communication links available for transmission. For instance a single link transmission 910 may be available. One or more of the plurality of coded sub-images or sub-video data units (e.g., 903) may be selected for transmission using the single link. Given the equal characteristics or priority among the sub-video data units, the one or more coded sub-images or sub-video data units may be selected randomly. In some cases, the group of sub-video data units may be selected based on the size or bitrate of the coded sub-video data unit and the transmission capability (e.g., bandwidth) of the available communication link. For instance, the total bitrate (bit per second) of the group of coded sub-video data units or the storage size of the group of the coded sub-video data units (bitrate * length) may match the bandwidth of a selected communication link (bit per second). The image data or video data may be reconstructed using the transmitted sub-video data 905. In some cases, the sub-video data that are not transmitted may be replaced with a value interpolated using pixels comprised by the transmitted sub-video data.

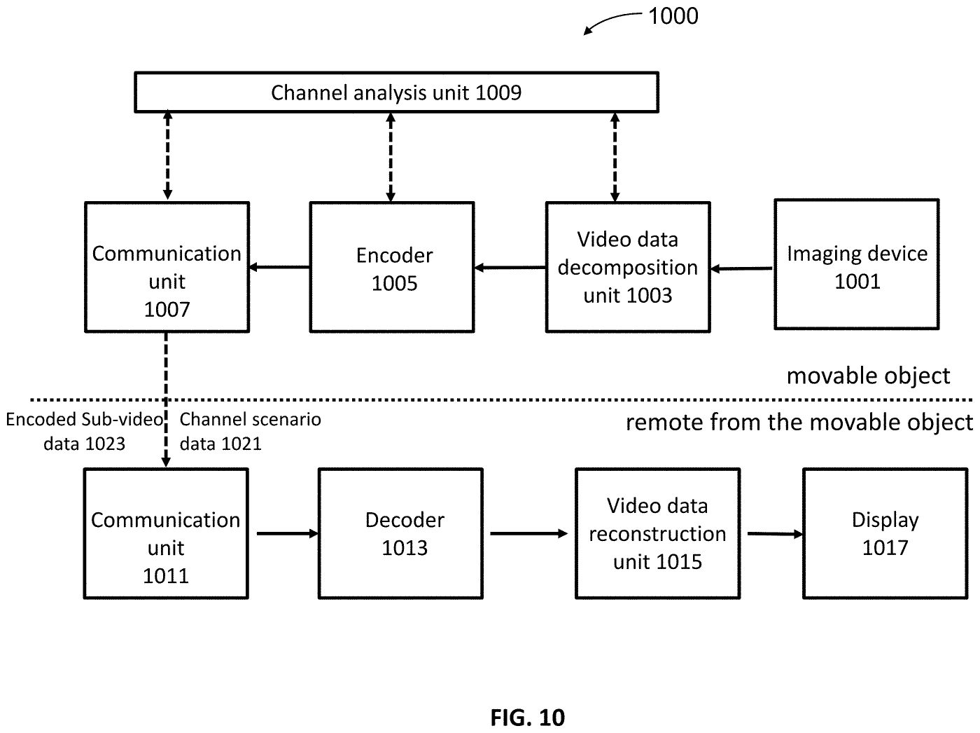

FIG. 10 shows a block diagram 1000 illustrating examples of components for adaptive video transmission, in accordance with embodiments. The plurality of components may allow for an adaptive switch between a symmetric multi-link channel scenario and an asymmetric multi-link channel scenario. The plurality of components may allow for a switch between a spatial sampling (e.g., down-sampling) decomposition method and a spatial transformation (e.g., Hadamard transform) decomposition method. The components may comprise a first group of components where at least one component of the first group is located onboard a movable object, and a second group of components located remotely from the movable object. In some embodiments, all of the component in the first group are located onboard the movable object. In some embodiments, some of the components such as the imaging device 1001 is onboard the movable object whereas the other components may be located remotely from the movable object. In some embodiments, one or more components from the second group of components may be located on a remote terminal or user terminal.

The first group of components may comprise an imaging device 1001, a video data decomposition unit 1003, one or more encoders 1005, a channel analysis unit 1009 and a communication unit 1007. The first group of components may be similar to the components described in FIG. 4, except that the communication unit 1007 may be configured to further transmit channel scenario data 1021 in addition to the encoded sub-video data 1023 to the remote terminal.

The channel scenario data 1021 may include information indicating the current channel scenario. The channel scenario may include a symmetric multi-link channel scenario or asymmetric multi-link channel scenario. In some cases, the channel scenario may be related to the decomposition method. For instance, when it is the symmetric multi-link channel scenario, spatial sampling method may be used, whereas when it is the asymmetric multi-link channel scenario, spatial transformation method may be used. Upon receipt of the channel scenario data, the video data reconstruction unit 1015 may employ the corresponding methods for reconstructing the image data or video data. For example, when the channel scenario data indicates current channel scenario is symmetric multi-link channel scenario or spatial sampling decomposition method, the video data reconstruction unit may replace the erroneous sub-images of sub-video data unit with interpolated data generated based on correct sub-images or sub-video data. When the channel scenario data indicates current channel scenario is asymmetric multi-link channel scenario or spatial transform decomposition method, the video data reconstruction unit may replace the erroneous sub-images of sub-video data unit with zero and apply inverse transform operations to the decoded sub-video data units.

The channel scenario data 1021 may be transmitted from the communication unit 1007 to the communication unit 1011 onboard the remote terminal. The channel scenario data may be transmitted using an additional channel. The channel scenario data may be transmitted using existing channels. For example, a datagram comprising the channel scenario data may be embedded into a field of existing data frames. The datagram may be embedded in a special field of a data frame or subframe that comprises at least a portion of the sub-image data. For instance, the datagram comprising the channel scenario data may be inserted into a frame control header (FCH) of a downlink subframe. The downlink subframe may comprise at least a portion of the coded sub-video data. In another instance, the datagram comprising the channel scenario data may be inserted into an Information Element (IE) field of a management frame (e.g., broadcasting frame, beacon frame, etc). The datagram comprising the channel scenario data need not be coded or modulated using the same coding or modulation schemes as the video data. The channel scenario data may be in any form such as comprising alphanumeric string.

The channel scenario data 1021 may be transmitted at set intervals. For example, the channel scenario data may be transmitted at about or less than every 0.01 seconds, 0.02 seconds, 0.05 seconds, 0.1 seconds, 0.2 seconds, 0.5 seconds, 1 second, 2 seconds, 5 seconds, 10 seconds, 30 seconds, 60 seconds, 5 minutes, or 10 minutes. In some cases, the channel scenario data 1021 may be generated and transmitted when an adaptive switch occur. For instance, the channel scenario data may be generated when the channel analysis unit sends a switch instruction to the video data decomposition unit.

The channel scenario data may be generated by the channel analysis unit 1009. The channel analysis unit 1009 can be the same as the channel analysis unit as described in FIG. 4.

In some embodiments, the channel analysis unit 1009 may be configured to assess one or more channel conditions or characteristics. The one or more channel conditions or characteristics may include, but not limited to, noise, interference, signal-to-noise ratio (SNR), bit error rate, fading rate, bandwidth, number of available channels, symmetry of available channels and the like.

The one or more channel characteristics may be measured or estimated by the channel analysis unit 1009. In some cases, the channel analysis unit may be configured to measure one or more of the characteristics or conditions such as noise, interference, signal-to-noise ratio (SNR), bit error rate, fading rate, or bandwidth. The conditions or characteristics can be measured using various methods such as using measurement subframes. The channel conditions or characteristics may be measured, e.g., in real time or at set intervals. For example, the channel conditions or characteristics may be measured at about or less than every 0.001 seconds, 0.002 seconds, 0.005 seconds, 0.01 seconds, 0.02 seconds, 0.05 seconds, 0.1 seconds, 0.2 seconds, 0.5 seconds, 1 second, 2 seconds, 5 seconds, 10 seconds, 30 seconds, 60 seconds, 5 minutes, or 10 minutes. In some cases, one or more of the channel conditions or characteristics such as the number of available communication links or bandwidth may be known to the channel analysis unit and such characteristics may not be measured dynamically or in real-time.

In some embodiments, characteristics such as symmetry or asymmetry of the multiple links may be estimated by the channel analysis unit 1009. The symmetry or asymmetry of the multiple links may be estimated by checking a signal strength or a location of the movable object. In some cases, the asymmetry of the multiple links may be estimated based on the environment of the radio communication. The symmetry or asymmetry information may be obtained by detecting a location of the movable object or the environment of the movable object. The environment may include objects or topographies and various other factors (e.g., weather) that may affect radio signal propagation. The environment may comprise any structures or factors that may affect, for example, noise, fading, reflection or other characteristics of radio signal propagation. In some cases, different environment may result in asymmetry of communication links. For instance, in in a cluttered or urban environment, the communication links may tend to be asymmetric such as due to the reflected propagation path cancelling the direct propagation path or different communication links may experience different propagation delay. In another instance, the communication links may tend to be symmetric in less cluttered environment. Alternatively, the information related to the channel characteristics, conditions or number of available channels may be measured. In some cases, the symmetry or asymmetry may be estimated by detecting a signal strength and/or round-trip time of a radio signal. The channel scenario data 1021 may be generated based on the symmetry or asymmetry assessment.

The provided method or system may be beneficial to provide an adaptive switch between the symmetric and asymmetric multi-link conditions, or between the multi-link and single-link conditions. The decomposition method may be selected in response to the information or instruction provided by the channel analysis unit. The decomposition method may be selected or changed during image capturing or prior to image capturing. The decomposition method may be selected or changed dynamically to be adapted for the change in channel conditions.

The imaging device 1001 may be carried by the movable object. The imaging device 1001 may be operably coupled to the movable object via a carrier. Optionally, the imaging device may be disposed within a housing of the movable object. In some alternative embodiments, the imaging device may be implemented as a stand-alone device and need not be provided on a movable object. The image data or video data captured by the imaging device may be transmitted to a video data decomposition unit 1003 and decomposed into a plurality of sub-video data units. The video data decomposition unit 1003 may be provided onboard the movable object. The video data decomposition unit may be implemented using one or more processors onboard the movable object or remote from the movable object. The plurality of sub-video data units may be encoded by one or more encoders 1005. The one or more encoders 1005 may be implemented using one or more processors. The one or more encoders may be implemented using software, hardware or a combination of both. The one or more processors onboard the movable object may include video codec processors for encoding the plurality of sub-video data units in parallel. The encoder as used herein may include a video encoder. The coded sub-video data units may be selected and/or organized for transmission by a channel analysis unit 1009. The channel analysis unit 1009 may be configured to organize the plurality of sub-video data units into groups and allocate one or more communication links or channels for transmitting the groups of organized data. The channel analysis unit may determine the channel/sub-video data allocation according to real-time channel conditions and characteristics of the sub-video data unit. The channel analysis unit may be configured to assess the one or more channel conditions or characteristics. The channel analysis unit may be implemented using one or more processors. The one or more processors may or may not be part of the communication unit. The communication unit 1007 may be located within a body of the movable object. The communication unit 1007 may include one or more processors configured to transmit the encoded sub-video data 1023 from the movable object directly or indirectly to the remote terminal. The communication unit 1007 may further transmit the channel scenario data 1021 to the remote terminal. In some cases, the channel scenario data may be transmitted using a different communication unit.

The communication unit 1007 onboard the movable object may be configured to transmit the encoded sub-video data 1023 to a communication unit 1011 remote from the movable object. The communication unit 1011 may or may not be located at a user terminal. The user terminal may or may not be located on the ground. The user terminal may be located remotely from the movable object. In some instances, the communication unit 1011 may be located at a ground station in communication with the movable object and the user terminal. The user terminal and the movable object may be in communication with each other via the communication units 1007 and 1011. The encoded sub-video data 1023 may be transmitted from the movable object to the user terminal via a downlink. The encoded sub-video data 1023 may be transmitted from the movable object to the user terminal via one or more communication links or channels. The user terminal may transmit various control signals (not shown) to the movable object via an uplink. The communication links or channels have been described elsewhere herein. In some cases, the communication unit 1007 may be a component of the imaging device and/or the encoder. For example, the imaging device and/or the encoder may comprise one or more transceivers. In some cases, the communication unit 1011 may be a component of the display device 1017 and/or a decoder 1013.

The communication unit 1011 may in turn transmit the encoded sub-video data to a decoder 1013. The decoder may include one or more decoders configured to decode the received sub-video data in parallel. The decoder may be a video decoder, or may comprise a video decoder. The decoder may be implemented using one or more processors at a user terminal and/or at a ground station. In some cases, the decoder may be implemented on a display device 1017. The decoder may be configured to decompress the processed sub-image data processed by the encoder. The decoder may be configured to decode the encoded sub-video data, and transmitted the decoded sub-video data to the video data reconstruction unit 1015.

The video data reconstruction unit 1015 is configured to reconstruct the image data or video data. The image data or video data may be reconstructed based on correctly received sub-video data along with a value assigned to erroneous sub-video data. The video data reconstruction unit 1015 may be configured to identify one or more erroneous sub-images or sub-video data. The video data reconstruction unit may identify the erroneous sub-images or sub-video data by detecting transmission error. Transmission error may be detected based on the specific transmission protocol, channel coding methods or various other factors. For example, transmission error may be detected by checking the redundancy bits compressed with the source bits (e.g., forward error correction). In another example, a transmission error may be detected when the round-trip time (RTT) exceeds certain value. The transmission error may be detected for one or more sub-images or one or more sub-video data units. In some cases, when an erroneous sub-image or sub-video data unit is identified, such data may not be used for reconstruction of the image frame.

In some embodiments, the video data reconstruction unit 1015 may be configured to reconstruct the image data or video data based on correctly received sub-video data or sub-images. The video data reconstruction unit 1015 may employ the corresponding methods for reconstructing the image data or video data based on the channel scenario data 1021. For example, when the channel scenario data indicates current channel scenario is symmetric multi-link channel scenario or spatial sampling decomposition method, the video data reconstruction unit 1015 may replace the erroneous sub-images of sub-video data unit with interpolated data generated based on correct sub-images or sub-video data. When the channel scenario data indicates current channel scenario is asymmetric multi-link channel scenario or spatial transform decomposition method, the video data reconstruction unit 1015 may replace the erroneous sub-images of sub-video data unit with zero and apply inverse transform operations to the decoded sub-video data units.

The video data reconstruction unit then transmits the video data to the display device 1017. The display device may be located at a user terminal. Alternatively, the display device may be operably coupled to and detachable from the user terminal. In some cases, the display device may be remote from the user terminal. The display device may be configured to display the reconstructed video data such as a FPV of the environment. A user may view the FPV of the environment on the display device.

The display device 1017 can be the same display as described FIG. 4. The display may be a screen. The display may or may not be a touchscreen. The display may be a light-emitting diode (LED) screen, OLED screen, liquid crystal display (LCD) screen, plasma screen, or any other type of screen. The display may be configured to show a graphical user interface (GUI). The GUI may show an image that may permit a user to control actions of the UAV. In some instances, the user may select a target from the image. The target may be a stationary target or a moving target. In other instances, the user may select a direction of travel from the image. The user may select a portion of the image (e.g., point, region, and/or object) to define the target and/or direction. The user may select the target and/or direction by changing the focus and/or direction of the user's gaze point on the screen (e.g., based on eye-tracking of the user's regions of interest). In some cases, the user may select the target and/or direction by moving his or her head in different directions and manners.

A user may touch a portion of the screen. The user may touch the portion of the screen by touching a point on the screen. Alternatively, the user may select a region on a screen from a pre-existing set of regions, or may draw a boundary for a region, a diameter of a region, or specify a portion of the screen in any other way. The user may select the target and/or direction by selecting the portion of the image with aid of a user interactive device (e.g., mouse, joystick, keyboard, trackball, touchpad, button, verbal commands, gesture-recognition, attitude sensor, thermal sensor, touch-capacitive sensors, or any other device). A touchscreen may be configured to detect location of the user's touch, length of touch, pressure of touch, and/or touch motion, whereby each of the aforementioned manner of touch may be indicative of a specific input command from the user.

The image on the display may show a view collected with aid of a payload of the movable object. For instance, an image collected by the imaging device may be shown on the display. This may be considered a first person view (FPV). In some instances, a single imaging device may be provided and a single FPV may be provided. Alternatively, multiple imaging devices having different fields of view may be provided. The views may be toggled between the multiple FPVs, or the multiple FPVs may be shown simultaneously. The multiple FPVs may correspond to (or can be generated by) different imaging devices, which may have different field of views. A user may use the user terminal to select a portion of the image collected by the imaging device to specify a target and/or direction of motion by the movable object.

In another example, the image on the display may show a map that may be generated with aid of information from a payload of the movable object. The map may optionally be generated with aid of multiple imaging devices (e.g., right camera, left camera, or more cameras), which may utilize stereo-mapping techniques. In some instances, the map may be generated based on positional information about the UAV relative to the environment, the imaging device relative to the environment, and/or the UAV relative to the imaging device. Positional information may include posture information, spatial location information, angular velocity, linear velocity, angular acceleration, and/or linear acceleration. The map may be optionally generated with aid of one or more additional sensors, as described in greater detail elsewhere herein. The map may be a two-dimensional map or a three-dimensional map. The views may be toggled between a two-dimensional and a three-dimensional map view, or the two-dimensional and three-dimensional map views may be shown simultaneously. A user may use the user terminal to select a portion of the map to specify a target and/or direction of motion by the movable object. The views may be toggled between one or more FPV and one or more map view, or the one or more FPV and one or more map view may be shown simultaneously. The user may make a selection of a target or direction using any of the views. The portion selected by the user may include the target and/or direction. The user may select the portion using any of the selection techniques as described.

In some embodiments, the image data may be provided in a 3D virtual environment that is displayed on the user terminal (e.g., virtual reality system or augmented reality system). The 3D virtual environment may optionally correspond to a 3D map. The virtual environment may comprise a plurality of points or objects that can be manipulated by a user. The user can manipulate the points or objects through a variety of different actions in the virtual environment. Examples of those actions may include selecting one or more points or objects, drag-and-drop, translate, rotate, spin, push, pull, zoom-in, zoom-out, etc. Any type of movement action of the points or objects in a three-dimensional virtual space may be contemplated. A user may use the user terminal to manipulate the points or objects in the virtual environment to control a flight path of the UAV and/or motion characteristic(s) of the UAV. A user may also use the user terminal to manipulate the points or objects in the virtual environment to control motion characteristic(s) and/or different functions of the imaging device.

For example, in some embodiments, a user may use the user terminal to implement target-pointing flight. The user may select one or more points on an image displayed on the user terminal. The image may be provided in a GUI rendered on the output device of the user terminal. When the user selects the one or more points, the selection may extend to a target associated with that point. In some cases, the selection may extend to a portion of the target. The point may be located on or proximate to the target in the image. The UAV may then fly towards and/or track the target. For example, the UAV may fly to a predetermined distance, position, and/or orientation relative to the target. In some instances, the UAV may track the target by following it at the predetermined distance, position, and/or orientation. The UAV may continue to move towards the target, track the target, or hover at the predetermined distance, position, and/or orientation to the target, until a new target instruction is received at the user terminal. A new target instruction may be received when the user selects another different one or more points on the image. When the user selects the different one or more points, the target selection may switch from the original target to a new target that is associated with the new one or more points. The UAV may then change its flight path and fly towards and/or track the new target.

In some other embodiments, a user may use the user terminal to implement direction-pointing flight. A user may select a point on an image displayed on the user terminal. The image may be provided in a GUI rendered on the output device of the user terminal. When the user selects the point, the selection may extend to a target direction associated with that point. The UAV may then fly in the direction. The UAV may continue to move in the direction until a countermanding condition is detected. For instance, the UAV may fly in the target direction until a new target direction instruction is received at the user terminal. A new target direction instruction may be received when the user selects another different point on the image. When the user selects a different point, the target direction selection may switch from the original direction to a new target direction that is associated with the new point. The UAV may then change its flight path and fly in the new target direction.

In some embodiments, the raw image data and/or the encoded video data may be directly transmitted to the user terminal without being stored in any form of medium. In some alternative embodiments, the raw image data captured by the imaging device and/or the encoded video data compressed by the encoder may be stored in a media storage (not shown) before the data is transmitted to the user terminal. The media storage may also be borne by the movable object. The media storage can be any type of storage medium capable of storing image or video data of a plurality of objects. The media storage can be provided as a CD, DVD, Blu-ray disc, hard disk, magnetic tape, flash memory card/drive, solid state drive, volatile or non-volatile memory, holographic data storage, and any other type of storage medium. As another example, the media storage can be a web server, an enterprise server, or any other type of computer server. The media storage can be computer programmed to accept requests (e.g., HTTP, or other protocols that can initiate data transmission) from one or more devices at the user terminal and to serve the user terminal with requested image data. In addition, the media storage can be a broadcasting facility, such as free-to-air, cable, satellite, and other broadcasting facility, for distributing image data. The media storage may also be a server in a data network (e.g., a cloud computing network). In some embodiments, the media storage may be located on-board the imaging device, the encoder, and/or the movable object. In some embodiments, the media storage may be located on the user terminal, such as a remote controller, a ground station, a server, etc. Any arrange or combination of the above components may be contemplated.

The channel analysis unit 1009 and video data decomposition unit 1003 can have one or more processors and at least one memory for storing program instructions. The processors may be located onboard the movable object. The processor(s) can be a single or multiple microprocessors, field programmable gate arrays (FPGAs), or digital signal processors (DSPs) capable of executing particular sets of instructions. Computer-readable instructions can be stored on a tangible non-transitory computer-readable medium, such as a flexible disk, a hard disk, a CD-ROM (compact disk-read only memory), and MO (magneto-optical), a DVD-ROM (digital versatile disk-read only memory), a DVD RAM (digital versatile disk-random access memory), or a semiconductor memory. Alternatively, the methods disclosed herein can be implemented in hardware components or combinations of hardware and software such as, for example, ASICs, special purpose computers, or general purpose computers.

The video data reconstruction unit 1015 can have one or more processors and at least one memory for storing program instructions. The processors may be located at the user terminal. The processor(s) can be a single or multiple microprocessors, field programmable gate arrays (FPGAs), or digital signal processors (DSPs) capable of executing particular sets of instructions. Computer-readable instructions can be stored on a tangible non-transitory computer-readable medium, such as a flexible disk, a hard disk, a CD-ROM (compact disk-read only memory), and MO (magneto-optical), a DVD-ROM (digital versatile disk-read only memory), a DVD RAM (digital versatile disk-random access memory), or a semiconductor memory. Alternatively, the methods disclosed herein can be implemented in hardware components or combinations of hardware and software such as, for example, ASICs, special purpose computers, or general purpose computers. The video data reconstruction unit may be a standalone device. Alternatively, the video data reconstruction unit may be a component of the decoder or a component of the display device.

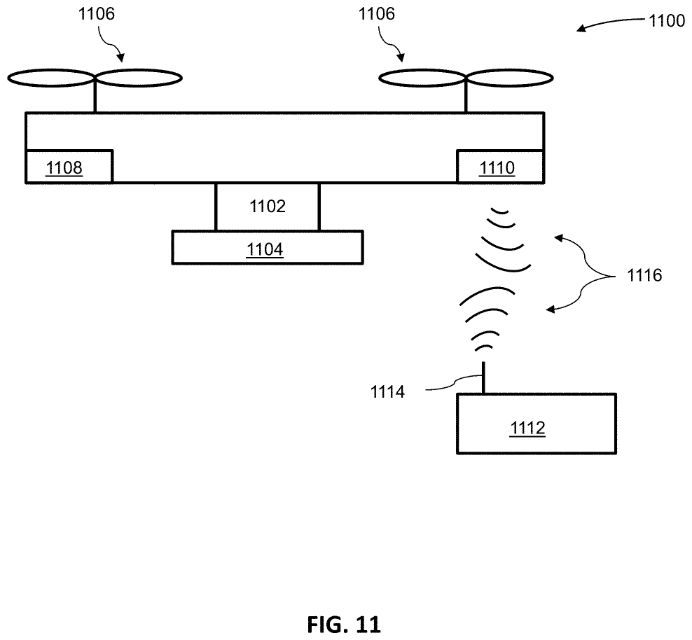

FIG. 11 illustrates a movable object 1100, in accordance with embodiments. Although the movable object 1100 is depicted as an aircraft, this depiction is not intended to be limiting, and any suitable type of movable object can be used, as described herein. One of skill in the art would appreciate that any of the embodiments described herein in the context of aircraft systems can be applied to any suitable movable object (e.g., an UAV). In some instances, the movable object may carry a payload 1104. The payload may be provided on the movable object 1100 with or without requiring a carrier 1102. The movable object 1100 may include propulsion mechanisms 1106, a sensing system 1108, and a communication system 1110.

The propulsion mechanisms 1106 can include one or more of rotors, propellers, blades, engines, motors, wheels, axles, magnets, or nozzles, as previously described. For example, the propulsion mechanisms 1106 may be self-tightening rotors, rotor assemblies, or other rotary propulsion units, as disclosed elsewhere herein. The movable object may have one or more, two or more, three or more, or four or more propulsion mechanisms. The propulsion mechanisms may all be of the same type. Alternatively, one or more propulsion mechanisms can be different types of propulsion mechanisms. The propulsion mechanisms 1106 can be mounted on the movable object 1100 using any suitable means, such as a support element (e.g., a drive shaft) as described elsewhere herein. The propulsion mechanisms 1106 can be mounted on any suitable portion of the movable object 1100, such on the top, bottom, front, back, sides, or suitable combinations thereof.

In some embodiments, the propulsion mechanisms 1106 can enable the movable object 1100 to take off vertically from a surface or land vertically on a surface without requiring any horizontal movement of the movable object 1100 (e.g., without traveling down a runway). Optionally, the propulsion mechanisms 1106 can be operable to permit the movable object 1100 to hover in the air at a specified position and/or orientation. One or more of the propulsion mechanisms 1106 may be controlled independently of the other propulsion mechanisms. Alternatively, the propulsion mechanisms 1106 can be configured to be controlled simultaneously. For example, the movable object 1100 can have multiple horizontally oriented rotors that can provide lift and/or thrust to the movable object. The multiple horizontally oriented rotors can be actuated to provide vertical takeoff, vertical landing, and hovering capabilities to the movable object 1100. In some embodiments, one or more of the horizontally oriented rotors may spin in a clockwise direction, while one or more of the horizontally rotors may spin in a counterclockwise direction. For example, the number of clockwise rotors may be equal to the number of counterclockwise rotors. The rotation rate of each of the horizontally oriented rotors can be varied independently in order to control the lift and/or thrust produced by each rotor, and thereby adjust the spatial disposition, velocity, and/or acceleration of the movable object 1100 (e.g., with respect to up to three degrees of translation and up to three degrees of rotation).

The sensing system 1108 can include one or more sensors that may sense the spatial disposition, velocity, and/or acceleration of the movable object 1100 (e.g., with respect to up to three degrees of translation and up to three degrees of rotation). The one or more sensors can include global positioning system (GPS) sensors, motion sensors, inertial sensors, proximity sensors, or image sensors. The sensing data provided by the sensing system 1108 can be used to control the spatial disposition, velocity, and/or orientation of the movable object 1100 (e.g., using a suitable processing unit and/or control module, as described below). Alternatively, the sensing system 1108 can be used to provide data regarding the environment surrounding the movable object, such as weather conditions, proximity to potential obstacles, location of geographical features, location of manmade structures, and the like.

The communication system 1110 enables communication with terminal 1112 having a communication system 1114 via wireless signals 1116. The communication systems 1110, 1114 may include any number of transmitters, receivers, and/or transceivers suitable for wireless communication. The communication may be one-way communication, such that data can be transmitted in only one direction. For example, one-way communication may involve only the movable object 1100 transmitting data to the terminal 1112, or vice-versa. The data may be transmitted from one or more transmitters of the communication system 1110 to one or more receivers of the communication system 1114, or vice-versa. Alternatively, the communication may be two-way communication, such that data can be transmitted in both directions between the movable object 1100 and the terminal 1112. The two-way communication can involve transmitting data from one or more transmitters of the communication system 1110 to one or more receivers of the communication system 1114, and vice-versa. The communication system may comprise a single antenna or multiple antennas.

In some embodiments, the terminal 1112 can provide control data to one or more of the movable object 1100, carrier 1102, and payload 1104 and receive information from one or more of the movable object 1100, carrier 1102, and payload 1104 (e.g., position and/or motion information of the movable object, carrier or payload; data sensed by the payload such as image data captured by a payload camera). In some instances, control data from the terminal may include instructions for relative positions, movements, actuations, or controls of the movable object, carrier and/or payload. For example, the control data may result in a modification of the location and/or orientation of the movable object (e.g., via control of the propulsion mechanisms 1106), or a movement of the payload with respect to the movable object (e.g., via control of the carrier 1102). The control data from the terminal may result in control of the payload, such as control of the operation of a camera or other image capturing device (e.g., taking still or moving pictures, zooming in or out, turning on or off, switching imaging modes, change image resolution, changing focus, changing depth of field, changing exposure time, changing viewing angle or field of view). In some instances, the communications from the movable object, carrier and/or payload may include information from one or more sensors (e.g., of the sensing system 1108 or of the payload 1104). The communications may include sensed information from one or more different types of sensors (e.g., GPS sensors, motion sensors, inertial sensor, proximity sensors, or image sensors). Such information may pertain to the position (e.g., location, orientation), movement, or acceleration of the movable object, carrier and/or payload. Such information from a payload may include data captured by the payload or a sensed state of the payload. The control data provided transmitted by the terminal 1112 can be configured to control a state of one or more of the movable object 1100, carrier 1102, or payload 1104. Alternatively or in combination, the carrier 1102 and payload 1104 can also each include a communication module configured to communicate with terminal 1112, such that the terminal can communicate with and control each of the movable object 1100, carrier 1102, and payload 1104 independently.

In some embodiments, the movable object 1100 can be configured to communicate with another remote device in addition to the terminal 1112, or instead of the terminal 1112. The terminal 1112 may also be configured to communicate with another remote device as well as the movable object 1100. For example, the movable object 1100 and/or terminal 1112 may communicate with another movable object, or a carrier or payload of another movable object. When desired, the remote device may be a second terminal or other computing device (e.g., computer, laptop, tablet, smartphone, or other mobile device). The remote device can be configured to transmit data to the movable object 1100, receive data from the movable object 1100, transmit data to the terminal 1112, and/or receive data from the terminal 1112. Optionally, the remote device can be connected to the Internet or other telecommunications network, such that data received from the movable object 1100 and/or terminal 1112 can be uploaded to a website or server.

In some embodiments, a system for controlling a movable object may be provided in accordance with embodiments. The system can be used in combination with any suitable embodiment of the systems, devices, and methods disclosed herein. The system can include a sensing module, processing unit, non-transitory computer readable medium, control module, and communication module.

The sensing module can utilize different types of sensors that collect information relating to the movable objects in different ways. Different types of sensors may sense different types of signals or signals from different sources. For example, the sensors can include inertial sensors, GPS sensors, proximity sensors (e.g., lidar), or vision/image sensors (e.g., a camera). The sensing module can be operatively coupled to a processing unit having a plurality of processors. In some embodiments, the sensing module can be operatively coupled to a transmission module (e.g., a Wi-Fi image transmission module) configured to directly transmit sensing data to a suitable external device or system. For example, the transmission module can be used to transmit images captured by a camera of the sensing module to a remote terminal.

The processing unit can have one or more processors, such as a programmable processor (e.g., a central processing unit (CPU)). The processing unit can be operatively coupled to a non-transitory computer readable medium. The non-transitory computer readable medium can store logic, code, and/or program instructions executable by the processing unit for performing one or more steps. The non-transitory computer readable medium can include one or more memory units (e.g., removable media or external storage such as an SD card or random access memory (RAM)). In some embodiments, data from the sensing module can be directly conveyed to and stored within the memory units of the non-transitory computer readable medium. The memory units of the non-transitory computer readable medium can store logic, code and/or program instructions executable by the processing unit to perform any suitable embodiment of the methods described herein. For example, the processing unit can be configured to execute instructions causing one or more processors of the processing unit to analyze sensing data produced by the sensing module. The memory units can store sensing data from the sensing module to be processed by the processing unit. In some embodiments, the memory units of the non-transitory computer readable medium can be used to store the processing results produced by the processing unit.

In some embodiments, the processing unit can be operatively coupled to a control module configured to control a state of the movable object. For example, the control module can be configured to control the propulsion mechanisms of the movable object to adjust the spatial disposition, velocity, and/or acceleration of the movable object with respect to six degrees of freedom. Alternatively or in combination, the control module can control one or more of a state of a carrier, payload, or sensing module.

The processing unit can be operatively coupled to a communication module configured to transmit and/or receive data from one or more external devices (e.g., a terminal, display device, or other remote controller). Any suitable means of communication can be used, such as wired communication or wireless communication. For example, the communication module can utilize one or more of local area networks (LAN), wide area networks (WAN), infrared, radio, WiFi, point-to-point (P2P) networks, telecommunication networks, cloud communication, and the like. Optionally, relay stations, such as towers, satellites, or mobile stations, can be used. Wireless communications can be proximity dependent or proximity independent. In some embodiments, line-of-sight may or may not be required for communications. The communication module can transmit and/or receive one or more of sensing data from the sensing module, processing results produced by the processing unit, predetermined control data, user commands from a terminal or remote controller, and the like.

The components of the system can be arranged in any suitable configuration. For example, one or more of the components of the system can be located on the movable object, carrier, payload, terminal, sensing system, or an additional external device in communication with one or more of the above. In some embodiments, one or more of the plurality of processing units and/or non-transitory computer readable media can be situated at different locations, such as on the movable object, carrier, payload, terminal, sensing module, additional external device in communication with one or more of the above, or suitable combinations thereof, such that any suitable aspect of the processing and/or memory functions performed by the system can occur at one or more of the aforementioned locations.

As used herein A and/or B encompasses one or more of A or B, and combinations thereof such as A and B. It will be understood that although the terms “first,” “second,” “third” etc. may be used herein to describe various elements, components, regions and/or sections, these elements, components, regions and/or sections should not be limited by these terms. These terms are merely used to distinguish one element, component, region or section from another element, component, region or section. Thus, a first element, component, region or section discussed below could be termed a second element, component, region or section without departing from the teachings of the present disclosure.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” or “includes” and/or “including,” when used in this specification, specify the presence of stated features, regions, integers, steps, operations, elements and/or components, but do not preclude the presence or addition of one or more other features, regions, integers, steps, operations, elements, components and/or groups thereof.

Furthermore, relative terms, such as “lower” or “bottom” and “upper” or “top” may be used herein to describe one element's relationship to other elements as illustrated in the figures. It will be understood that relative terms are intended to encompass different orientations of the elements in addition to the orientation depicted in the figures. For example, if the element in one of the figures is turned over, elements described as being on the “lower” side of other elements would then be oriented on the “upper” side of the other elements. The exemplary term “lower” can, therefore, encompass both an orientation of “lower” and “upper,” depending upon the particular orientation of the figure. Similarly, if the element in one of the figures were turned over, elements described as “below” or “beneath” other elements would then be oriented “above” the other elements. The exemplary terms “below” or “beneath” can, therefore, encompass both an orientation of above and below.

While some embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure. Numerous different combinations of embodiments described herein are possible, and such combinations are considered part of the present disclosure. In addition, all features discussed in connection with any one embodiment herein can be readily adapted for use in other embodiments herein. It is intended that the following claims define the scope of the invention and that methods and structures within the scope of these claims and their equivalents be covered thereby.

What is claimed is:

1. A method for transmitting video from a movable object, the method comprising:
decomposing, with aid of one or more processors, video data into a plurality of sub-video data units;
encoding the plurality of sub-video data units individually to generate a plurality of coded sub-video data units; and
selecting, with aid of the one or more processors, at least one of the plurality of coded sub-video data units for transmission according to one or more characteristics of the sub-video data units and one or more channel conditions of a plurality of channels.

2. The method of claim 1, wherein the video data comprises one or more image frames and wherein each image frame is decomposed into a plurality of sub-images.

3. The method of claim 2, wherein each image frame is spatially decomposed into the plurality of sub-images.

4. The method of claim 1, wherein a length of each sub-video data unit is same as a length of the video data.

5. The method of claim 1, wherein the plurality of sub-video data units are encoded in parallel.

6. The method of claim 1, wherein the one or more characteristics of the sub-video data unit include at least one of a size of the coded sub-video data unit, or an energy concentration.

7. The method of claim 6, wherein the plurality of sub-video data units are prioritized according to the energy concentration.

8. The method of claim 1, wherein the one or more channel conditions include at least one of noise, interference, signal-to-noise ratio, bit error rate, fading rate, or bandwidth.

9. The method of claim 1, wherein each individual coded sub-video data unit is transmitted using one of the plurality of channels.

10. The method of claim 9, wherein different coded sub-video data units are assigned to different channels according to priorities of the sub-video data units and the one or more channel conditions.

11. The method of claim 9, wherein different coded sub-video data units are assigned to different channels according to sizes of the coded sub-video data units and bandwidths of the channels.

12. The method of claim 1, wherein the plurality of sub-video data units are organized into one or more groups according to the one or more channel conditions.

13. The method of claim 1, further comprising identifying one or more erroneous sub-images or one or more erroneous sub-video data units.

14. The method of claim 13, further comprising assigning one or more values to the one or more erroneous sub-images or the one or more erroneous sub-video data units.

15. The method of claim 1, further comprising reconstructing the video data using the sub-video data units.

16. The method of claim 15, wherein the video data is reconstructed by applying an inverse transformation.

17. The method of claim 15, wherein the video data is reconstructed based on sub-video data units that are not erroneous and values assigned to one or more erroneous sub-video data units.

18. A system for transmitting video from a movable object, the system comprising:
one or more imaging devices configured to collect video data; and
one or more processors onboard the movable object and individually or collectively configured to:
decompose the video data into a plurality of sub-video data units;
encode the plurality of sub-video data units individually to generate a plurality of coded sub-video data units; and
select at least one of the plurality of coded sub-video data units for transmission according to one or more characteristics of the sub-video data units and one or more channel conditions of a plurality of channels.

19. The system of claim 18, wherein the video data comprises one or more image frames and wherein each image frame is decomposed into a plurality of sub-images.

20. The system of claim 18, wherein the plurality of sub-video data units are encoded in parallel.
